(19) United States
(12) Patent Application Publication
(10) Pub. No.: US 2026/0301479 A1
(43) Pub. Date: Oct. 1, 2026

(54) SYSTEMS AND METHODS FOR DETECTING AND COMPENSATING FOR CHANGING SELF-DRIVING VEHICLE PERFORMANCE

(71) Applicant: ROCKWELL AUTOMATION CANADA LTD., Cambridge (CA)

(72) Inventors: Dan Lu GUO, Waterloo (CA); Krispin Alexander DAVIES, Kitchener (CA); Natesh NARAIN, Kitchener (CA); Karen Janelle BODIE, Vancouver (CA); Jason MERCER, Kitchener (CA); Peiyi CHEN, Waterloo (CA); Joseph LOESCH, Milverton (CA); Matthew KOWALCZYKOWSKI, Kitchener (CA); Amer KEBLAWI, Kitchener (CA); Robert DAM, Kitchener (CA)

(21) Appl. No.: 19/344,895

(22) Filed: Sep. 30, 2025

Related U.S. Application Data
(63) Continuation-in-part of application No. 19/095,540, filed on Mar. 31, 2025.

(51) Int. Cl. G07C 5/04

(52) U.S. Cl. CPC G07C 5/04

(57) ABSTRACT

Various embodiments described herein generally relate to systems and methods for improving operation of a self-driving vehicle based on continuous behavioural observations. An example method involves generating a vehicle dynamic model for the self-driving vehicle to represent an expected individual behaviour of the self-driving vehicle, and operating a processor of the self-driving vehicle to, during operation: collect operation data associated with the operation of the self-driving vehicle; determine whether the operation data indicates an unexpected behaviour in relation to the expected individual behaviour; and in response to determining the operation data indicates the unexpected behaviour, determine an operational response to the unexpected behaviour. The vehicle dynamic model may include a plurality of subsystem models each adapted to represent an expected individual behaviour of a corresponding subsystem of the self-driving vehicle.

### CROSS-REFERENCE TO RELATED APPLICATIONS

This application is a continuation-in-part application of United States patent application no. 19/095,540 filed on Mar. 31, 2025 and entitled “SYSTEMS AND METHODS FOR DETECTING AND COMPENSATING FOR CHANGING SELF-DRIVING VEHICLE PERFORMANCE”. The entirety of United States patent application no. 19/095,540 is hereby incorporated by reference for all purposes.

### FIELD

The various embodiments described herein generally relate to self-driving vehicles and more specifically, to systems and methods for detecting and compensating for changing self-driving vehicle performance.

### BACKGROUND

Autonomous or self-driving vehicles are increasingly used for various different applications. On roads, for example, self-driving vehicles include autonomous cars, and in industrial environments, self-driving vehicles include autonomous material-transport vehicles. The performance of a self-driving vehicle typically degrades over the course of its operational life due to wear and tear of hardware components.

Known systems for monitoring the performance of self-driving vehicles are largely manual. As the complexity of the hardware and the autonomous operation of a self-driving vehicle increases, the volume of data generated by the self-driving vehicle also increases significantly. The management and/or analysis of that data to detect performance changes can be difficult and can consume a large amount of human resources and time. Accordingly, there is a need for autonomous continuous self-monitoring and self-calibration of self-driving vehicles.

### SUMMARY OF VARIOUS EMBODIMENTS

According to one broad aspect of the teachings herein, there is provided in at least one embodiment, a method for improving operation of a self-driving vehicle based on continuous behavioural observations. The method involves causing at least one processor of the self-driving vehicle to, while in operation: collect, using at least one sensor coupled to the self-driving vehicle and in communication with the at least one processor, operation data associated with the operation of the self-driving vehicle; determine whether the operation data is indicative of an unexpected behaviour in relation to an expected individual behaviour of the self-driving vehicle as defined by at least one vehicle dynamic model adapted to represent the expected individual behaviour of the self-driving vehicle, wherein the at least one vehicle dynamic model includes a plurality of subsystem models each adapted to represent an expected individual behaviour of a corresponding subsystem of the self-driving vehicle; and in response to determining the operation data is indicative of the unexpected behaviour, determine an operational response to adapt the unexpected behaviour for the self-driving vehicle based on the expected individual behaviour.

In some embodiments, causing the at least one processor of the self-driving vehicle to collect the operation data involves causing the at least one processor of the self-driving vehicle to collect, using the at least one sensor coupled to the self-driving vehicle and in communication with the at least one processor, environment data associated with an environment through which the self-driving vehicle is operating.

In some embodiments, the environment data includes surface data associated with a surface across which the self-driving vehicle is operating.

In some embodiments, the at least one sensor is configured to collect data representing performance of a system of the self-driving vehicle and the method further involves causing the at least one processor to determine the environment data based at least partially on the performance of the system.

In some embodiments, the system includes a drivetrain of the self-driving vehicle.

In some embodiments, causing the at least one processor of the self-driving vehicle to collect the operation data involves causing the at least one processor of the self-driving vehicle to collect, using the at least one sensor coupled to the self-driving vehicle and in communication with the at least one processor, physical condition data associated with a physical condition of the self-driving vehicle.

In some embodiments, the physical condition data includes drivetrain data associated with a state of a drivetrain of the self-driving vehicle.

In some embodiments, the physical condition data includes battery data associated with a state of a battery of the self-driving vehicle.

In some embodiments, the physical condition data includes payload data associated with a state of a payload of the self-driving vehicle.

In some embodiments, the plurality of subsystem models includes a first subsystem model based on a first set of data and a second subsystem model based on a second set of data, the first set of data different from the second set of data.

In another aspect, in accordance with the teachings herein, there is provided in at least one embodiment, a self-driving vehicle apparatus. The self-driving vehicle apparatus includes at least one processor configured to, while in operation: collect, using at least one sensor coupled to the self-driving vehicle and in communication with the at least one processor, operation data associated with the operation of the self-driving vehicle; determine whether the operation data is indicative of an unexpected behaviour in relation to an expected individual behaviour of the self-driving vehicle as defined by at least one vehicle dynamic model adapted to represent the expected individual behaviour of the self-driving vehicle, wherein the at least one vehicle dynamic model includes a plurality of subsystem models each adapted to represent an expected individual behaviour of a corresponding subsystem of the self-driving vehicle; and in response to determining the operation data is indicative of the unexpected behaviour, determine an operational response to adapt the unexpected behaviour for the self-driving vehicle based on the expected individual behaviour.

In some embodiments, the at least one processor configured to collect the operation data includes the at least one processor configured to collect, using the at least one sensor coupled to the self-driving vehicle and in communication with the at least one processor, environment data associated with an environment through which the self-driving vehicle is operating.

In some embodiments, the environment data includes surface data associated with a surface across which the self-driving vehicle is operating.

In some embodiments, the at least one sensor is configured to collect data representing performance of a system of the self-driving vehicle and the at least one processor is further configured to determine the environment data based at least partially on the performance of the system.

In some embodiments, the system of the self-driving vehicle includes a drivetrain of the self-driving vehicle.

In some embodiments, the at least one processor configured to collect the operation data includes the at least one processor configured to collect, using the at least one sensor coupled to the self-driving vehicle and in communication with the at least one processor, physical condition data associated with a physical condition of the self-driving vehicle.

In some embodiments, the physical condition data includes drivetrain data associated with a state of a drivetrain of the self-driving vehicle.

In some embodiments, the physical condition data includes battery data associated with a state of a battery of the self-driving vehicle.

In some embodiments, the physical condition data includes payload data associated with a state of a payload of the self-driving vehicle.

In some embodiments, the plurality of subsystem models includes a first subsystem model based on a first set of data and a second subsystem model based on a second set of data, the first set of data different from the second set of data.

It will be appreciated that the foregoing summary sets out representative aspects of embodiments to assist skilled readers in understanding the following detailed description. Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a block diagram of example self-driving vehicles in communication with a data analysis system, according to at least one embodiment.

FIG. 2 is a block diagram of an example self-driving vehicle, according to at least one embodiment.

FIG. 3 is another block diagram of an example self-driving vehicle, according to at least one embodiment.

FIG. 4 is a flowchart illustrating an example method for improving operation of a self-driving vehicle based on continuous behavioural observation of the self-driving vehicle, according to at least one embodiment.

FIG. 5 is a flowchart illustrating an example method for generating a vehicle dynamic model specific to, or individualized to, a self-driving vehicle, according to at least one embodiment.

FIG. 6 is a flowchart illustrating an example method for determining an operational response to an unexpected behaviour (or behaviours) of a self-driving vehicle being detected, according to at least one embodiment.

FIG. 7 is a flowchart illustrating an example method for updating a dynamic model of a self-driving vehicle, according to at least one embodiment.

Further aspects and features of the example embodiments described herein will appear from the following description taken together with the accompanying drawings.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION OF THE EMBODIMENTS

A self-driving vehicle can include various sensors for sensing its environment. The various sensors can be used to facilitate autonomous navigation within the self-driving vehicle’s environment with minimal to no human input. For example, a self-driving vehicle may use optical, RADAR, LIDAR, SONAR, GPS, odometry, or inertial measurement sensors, to perceive its surroundings and/or its operating state. The sensor data can then be interpreted by the self-driving vehicle, a data analysis system and/or a fleet management system to identify obstacles and determine appropriate operation. The various sensors employed by a self-driving vehicle can produce large volumes of sensor data.

Self-driving vehicles can also generate large amounts of other data. For example, a self-driving vehicle may generate various data related to autonomous operation, such as an electronic map for navigation. The self-driving vehicle may also perform complex processing of the sensor data that results in the generation of additional data.

The data generated by or collected by a self-driving vehicle can be analyzed in order to monitor its operation and/or predict potential malfunctions of the self-driving vehicle (or of one or more components of the self-driving vehicle). For example, the collected data may be compared against one or more baseline values of expected behaviour of the self-driving vehicle to determine whether the self-driving vehicle is functioning as expected. Based on the monitoring of the self-driving vehicle, maintenance schedules for the self-driving vehicle can be determined or predicted. The self-driving vehicle can respond accordingly to a detected or predicted malfunction.

The embodiments described herein provide systems and methods for monitoring the operation of one or more self-driving vehicles. The described embodiments can facilitate the generation of a dynamic model that represents expected behaviour of a self-driving vehicle. The dynamic model can be specific to or individualized to a specific self-driving vehicle. Data collected by the self-driving vehicle (or one or more sensors that are independent of the self-driving vehicle) can be compared against the dynamic model of the self-driving vehicle to determine whether behaviour of the self-driving vehicle is as expected. If the behaviour is not as expected, the self-driving vehicle can address the unexpected behaviour accordingly.

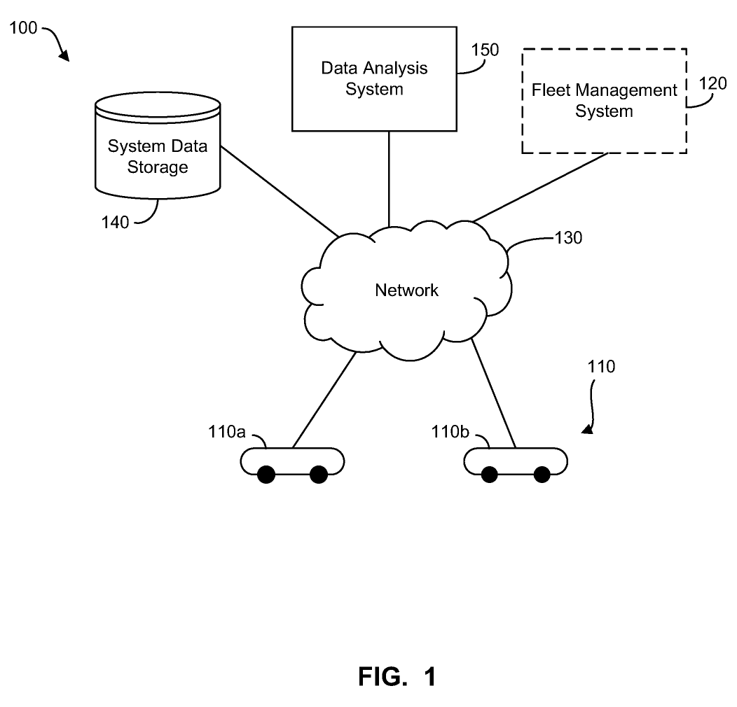

Reference is now made to FIG. 1, which shows a block diagram 100 illustrating example self-driving vehicles 110a, 110b (collectively referred to as the self-driving vehicles 110) in communication with a data analysis system 150, a system data storage 140, and, optionally, a fleet management system 120, via a network 130. While FIG. 1 shows example self-driving vehicles 110a, 110b for illustrative purposes, fewer or more self-driving vehicles 110 can operate with the fleet management system 120. In some embodiments, the fleet management system 120 may perform one or more functions of the data analysis system 150 so that a separate data analysis system 150 may not be required. In some embodiments, the fleet management system 120 may perform one or more functions of the data analysis system 150 in parallel with another data analysis system 150.

The network 130 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, Bluetooth mesh network and others, including any combination of these, capable of interfacing with, and enabling communication between the self-driving vehicles 110, the data analysis system 150, the system data storage 140, and/or the fleet management system 120. In some embodiments, the self-driving vehicles 110 can communicate with each other via the network 130. For example, self-driving vehicle 110a can communicate with self-driving vehicle 110b via the network 130. In some embodiments, self-driving vehicle 110a can communicate with self-driving vehicle 110b directly via onboard communication components.

The system data storage 140 can store data related to the self-driving vehicles 110, the data analysis system 150, and/or the fleet management system 120. The system data storage 140 can include RAM, ROM, one or more hard drives, one or more flash drives or some other suitable data storage elements such as disk drives, etc. In some embodiments, the system data storage 140 can be located at the fleet management system 120 and/or the data analysis system 150.

For example, the system data storage 140 can store electronic maps related to the operating environment of the self-driving vehicles 110. The electronic maps located on system data storage 140 can be accessible for download, via the network 130, by the fleet management system 120 and/or the self-driving vehicles 110.

The fleet management system 120 can operate to direct and/or monitor the operation of the self-driving vehicles 110. In some embodiments, the self-driving vehicles 110 can operate within a decentralized network – without, or at least with minimal, involvement of the fleet management system 120, or with one or more functions of the fleet management system 120 distributed across the self-driving vehicles 110.

In some embodiments, the fleet management system 120 includes a plurality of fleet management systems 120. The plurality of fleet management systems 120 can, for example, trade control and/or monitoring of the self-driving vehicles 110 between different ones of the fleet management systems 120. Additionally, or alternatively, different fleet management systems 120 of the plurality of fleet management systems 120 can each control and/or monitor different aspects of the self-driving vehicles 110. Additionally, or alternatively, different fleet management systems 120 of the plurality of fleet management systems 120 can each share control and/or monitoring of the self-driving vehicles 110.

The fleet management system 120 can include a processor, a data storage, and a communication component (not shown). For example, the fleet management system 120 can be any computing device, such as, but not limited to, an electronic tablet device, a personal computer, workstation, server, portable computer, mobile device, personal digital assistant, laptop, smart phone, WAP phone, an interactive television, video display terminals, gaming consoles, head mounted display, and portable electronic devices or any combination of these. The components of the fleet management system 120 can be provided over a wide geographic area and in communication via the network 130.

The processor of the fleet management system 120 can include any suitable processors, controllers or digital signal processors that can provide sufficient processing power depending on the configuration, purposes and requirements of the fleet management system 120. In some embodiments, the processor can include more than one processor with each processor being configured to perform different dedicated tasks.

The data storage of the fleet management system 120 can include random access memory (RAM), a read-only memory (ROM), an erasable programmable read-only memory (EPROM, EEPROM, or Flash memory), one or more hard drives, one or more flash drives or some other suitable data storage elements such as disk drives, etc.

The communication component of the fleet management system 120 can include any interface that enables the fleet management system 120 to communicate with other devices and systems. In some embodiments, the communication component can include at least one of a serial port, a parallel port or a USB port. The communication component may also include at least one of an Internet, Local Area Network (LAN), Ethernet, Firewire, modem or digital subscriber line connection. Various combinations of these elements may be incorporated within the communication component. For example, the communication component may receive input from various input devices, such as a mouse, a keyboard, a touch screen, a thumbwheel, a track-pad, a track-ball, a card-reader, voice recognition software and the like depending on the requirements and implementation of the fleet management system 120.

In some embodiments, the fleet management system 120 can generate commands for the self-driving vehicles 110. For example, the fleet management system 120 can generate and transmit navigational commands to the self-driving vehicles 110. The navigational commands can direct the self-driving vehicles 110 to navigate to one or more destination locations located within the operating environment of the self-driving vehicles 110. For example, the destination locations can correspond to locations where the self-driving vehicles 110 are required to pick up or drop off loads.

In some embodiments, the fleet management system 120 can transmit only the destination locations to the self-driving vehicles 110 and the self-driving vehicles 110 can then navigate themselves to the destination locations. The fleet management system 120 can transmit the destination locations in various formats, such as, but not limited to, a set of Global Positioning System (GPS) coordinates, or coordinates defined relative to an electronic map accessible to the self-driving vehicles 110 and the fleet management system 120. The destination locations, in some embodiments, can be identified with respect to known objects or landmarks within the operating environment of the self-driving vehicles 110. For example, the self-driving vehicles 110 can identify the location of the object or landmark on an electronic map, and navigate to the object or landmark.

The fleet management system 120 can also transmit action commands to the self-driving vehicles 110. Action commands can define an action that the self-driving vehicles 110 are required to perform at a destination location, for example. An example action command can indicate that the self-driving vehicle 110a is to pick up a load at a first destination location, and drop off the load at a second destination location. When the action command requires the self-driving vehicle 110a to pick up a load, the fleet management system 120 can include information about the load within the action command, such as image data or text data associated with the load. The image data can include an image of the load and the text data can include load descriptions, such as dimensions, color, size, and/or weight. The image and text data can assist the self-driving vehicles 110 with identifying the load.

In some embodiments, one or more commands for the self-driving vehicles 110 generated by the fleet management system 120 may be referred to as a mission.

In some embodiments, the fleet management system 120 can perform the functions of the data analysis system 150 so that the data analysis system 150 does not need to be provided separately.

The data analysis system 150 can include a processor, a data storage, and a communication component (not shown). For example, the data analysis system 150 can be any computing device, such as, but not limited to, an electronic tablet device, a personal computer, workstation, server, portable computer, mobile device, personal digital assistant, laptop, smart phone, WAP phone, an interactive television, video display terminals, gaming consoles, and portable electronic devices or any combination of these. The components of the data analysis system 150 can be provided over a wide geographic area and in communication via the network 130.

The processor of the data analysis system 150 can include any suitable processors, controllers or digital signal processors that can provide sufficient processing power depending on the configuration, purposes and requirements of the data analysis system 150. In some embodiments, the processor can include more than one processor with each processor being configured to perform different dedicated tasks.

The data storage of the data analysis system 150 can include random access memory (RAM), a read-only memory (ROM), an erasable programmable read-only memory (EPROM, EEPROM, or Flash memory), one or more hard drives, one or more flash drives or some other suitable data storage elements such as disk drives, etc.

The communication component of the data analysis system 150 can include any interface that enables the data analysis system 150 to communicate with other devices and systems. In some embodiments, the communication component can include at least one of a serial port, a parallel port or a USB port. The communication component may also include at least one of an Internet, Local Area Network (LAN), Ethernet, Firewire, modem or digital subscriber line connection. Various combinations of these elements may be incorporated within the communication component. For example, the communication component may receive input from various input devices, such as a mouse, a keyboard, a touch screen, a thumbwheel, a track-pad, a track-ball, a card-reader, voice recognition software and the like depending on the requirements and implementation of the data analysis system 150.

The data analysis system 150 can receive data from the self-driving vehicles 110 and/or the fleet management system 120. In some embodiments, the data analysis system 150 may receive operation data from the self-driving vehicles 110 via the fleet management system 120. As will be described in further detail below, the data analysis system 150 can perform various analyses on operation data received from the self-driving vehicles 110 and/or the fleet management system 120. It should be appreciated that, in some embodiments, the fleet management system 120 may perform one or more functions of the data analysis system 150.

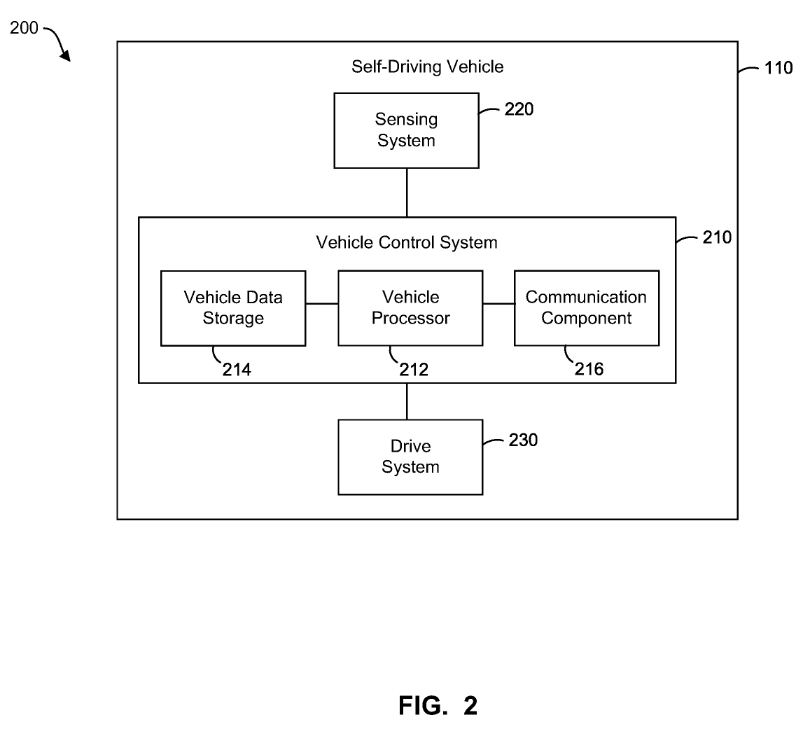

Reference is now made to FIG. 2, which illustrates a block diagram 200 of an example self-driving vehicle 110. The self-driving vehicle 110 can include a vehicle control system 210, a sensing system 220, and a drive system 230. The vehicle control system 210 includes a vehicle processor 212, a vehicle data storage 214, and a communication component 216. Components 210, 212, 214, 216, 220, and 230 are illustrated separately in FIG. 2, for ease of exposition. In some embodiments, one or more of the components 210, 212, 214, 216, 220, and 230 can be combined into fewer components, or separated into further components. In some embodiments, parts of a component can be combined with another part of another component.

The vehicle processor 212 can include any suitable processor, controller or digital signal processor that can provide sufficient processing power depending on the configuration, purposes and requirements of the self-driving vehicle 110. In some embodiments, the vehicle processor 212 can include more than one processor with each processor being configured to perform different dedicated tasks.

The vehicle processor 212 can operate the vehicle data storage 214, the communication component 216, the sensing system 220, and the drive system 230. For example, the vehicle processor 212 can operate the drive system 230 to navigate to the destination location as identified by the fleet management system 120. The vehicle processor 212 can also control the vehicle data storage 214, the communication component 216, the sensing system 220, and the drive system 230, as necessary, to implement the action commands received from the fleet management system 120. The operation of the vehicle processor 212 can be based on data collected from the vehicle data storage 214, the communication component 216, the sensing system 220, and/or the drive system 230, in some embodiments. The vehicle processor 212 can operate to process data received from the sensing system 220.

The vehicle data storage 214 can include RAM, ROM, one or more hard drives, one or more flash drives or some other suitable data storage elements such as disk drives, etc. For example, the vehicle data storage 214 can include volatile and non-volatile memory. Non-volatile memory can store computer programs consisting of computer-executable instructions, which can be loaded into the volatile memory for execution by the vehicle processor 212. Operating the vehicle processor 212 to carry out a function can involve executing instructions (e.g., a software program) that can be stored in the vehicle data storage 214 and/or transmitting or receiving inputs and outputs via the communication component 216. The vehicle data storage 214 can also store data input to, or output from, the vehicle processor 212, which can result from the course of executing the computer-executable instructions for example.

In some embodiments, the vehicle data storage 214 can store data related to the operation of the self-driving vehicle 110, such as one or more electronic maps of its operating environment and/or operating parameters. The vehicle data storage 214 can store data tables, data processing algorithms (e.g., image processing algorithms), as well as other data and/or operating instructions which can be used by the vehicle processor 212.

The communication component 216 can include any interface that enables the self-driving vehicle 110 to communicate with other components, and external devices and systems. In some embodiments, the communication component 216 can include at least one of a serial port, a parallel port or a USB port. The communication component 216 may also include a wireless transmitter, receiver, or transceiver for communicating with a wireless communications network (e.g. using an IEEE 802.11 protocol or similar). The wireless communications network can include at least one of an Internet, Local Area Network (LAN), Ethernet, Firewire, Bluetooth, modem or digital subscriber line connection. Various combinations of these elements may be incorporated within the communication component 216. For example, the communication component 216 may receive input from various input devices, such as a mouse, a keyboard, a touch screen, a thumbwheel, a track-pad, a track-ball, a card-reader, voice recognition software and the like depending on the requirements and implementation of the self-driving vehicle 110. For example, the communication component 216 can receive commands and/or data from the fleet management system 120, the data analysis system 150, and/or another autonomous vehicle (e.g., another autonomous vehicle operating within the operating environment).

The communication component 216 can receive information about obstacles and/or unexpected objects located in the vehicle’s operating environment directly from other autonomous vehicles within the same operating environment and/or indirectly via the fleet management system 120. The vehicle processor 212 may also transmit, via the communication component 216 for example, information related to obstacles and/or unexpected objects identified in its operating environment to other autonomous vehicles directly or indirectly via the fleet management system 120.

The sensing system 220 can monitor the environment of the self-driving vehicle 110. The sensing system 220 can include one or more sensors for capturing information related to the environment. The information captured by the sensing system 220 can be applied for various purposes, such as, but not limited to, localization, navigation and/or mapping. In some embodiments, the sensing system 220 includes one or more optical sensors. For example, the sensing system 220 can include, but not limited to, optical sensors equipped with depth perception capabilities, infrared (IR) capabilities, radar capabilities or sonar capabilities. The optical sensors can include imaging sensors (e.g., photographic and/or video cameras), and range-finding sensors (e.g., time of flight sensors, Light Detection and Ranging (LIDAR) devices which generate and detect reflections of pulsed laser from objects proximal to the self-driving vehicle 110, etc.). The sensing system 220 can also include navigational sensors, such as ground positioning system (GPS) sensors, as well as sensors that detect guiding infrastructure installed within the operating environment. Example sensors that detect guiding infrastructure can include, but not limited to, magnetic sensors that detect magnetic tape within a facility warehouse, and/or optical sensors that detect visual navigational indicators within the operating environment.

The sensing system 220 can also include one or more sensors for monitoring the various components and subcomponents of the self-driving vehicle 110. In some embodiments, the sensing system can monitor the vehicle control system 210, the drive system 230, and/or subcomponents thereof. For example, the sensing system 220 may include, but is not limited to, sensors for measuring voltage, current, velocity, acceleration, torque and/or temperature.

In some embodiments, the sensing system 220 can include a sensing processor that receives data collected by the sensors and processes the collected data. The sensing processor can operate independently from the vehicle processor 212. In some other embodiments, the sensing system 220 can receive the data collected by the sensors and transmit the collected data to the vehicle processor 212 for further processing.

The vehicle processor 212 can receive the data collected by the sensing system 220, and can apply the collected data to assist with navigating the self-driving vehicle 110 within its operating environment. For example, the vehicle processor 212 can receive environment data from the sensing system 220 in respect of the environment (e.g., a landmark) and can cross-reference the received environment data against the electronic map to assist with localizing the self-driving vehicle 110 and to navigate the self-driving vehicle 110 accordingly. The vehicle processor 212 can also use data collected by the sensing system 220 to determine locations for load pick-up and drop-off. For example, the sensing system 220 can collect data related to visual markers associated with pick-up and drop-off locations. The sensing system 220 can then transmit the collected data to the vehicle processor 212 for processing, or can determine the associated location before transmitting the location data to the vehicle processor 212. Example visual indicators can include, but not limited to, corner tape or graphic patterns placed on the ground for identifying the pick-up or drop-off location. In some examples, the sensing system 220 can include optical sensors and/or LIDAR sensors operable for detecting the visual indicators.

The sensing system 220 can also assist the vehicle processor 212 with executing action commands, such as those received from the fleet management system 120. For example, when executing the action command related to a load pick-up, the sensing system 220 can operate to collect image data related to the environment of the self-driving vehicle 110 to assist the vehicle processor 212 with identifying the load and orienting with respect to the load for the pick-up.

In some embodiments, the sensing system 220 can be operated to monitor the operating environment of the self-driving vehicle 110 for the purpose of minimizing and/or avoiding collisions.

The sensing system 220 can include sensors dedicated for collision avoidance, in some embodiments, or can use existing sensors within the sensing system 220 for collision avoidance. In contrast with sensor data required for localization, navigation and/or mapping, the sensor data required for collision avoidance can be lower resolution. For example, sensors such as LIDAR devices and time-of-flight sensors can generate robust signals that can be quickly transmitted and processed, which can be important for collision avoidance. In some embodiments, the vehicle processor 212 can use the data collected from the sensing system 220 for avoidance detection, even though the sensor data may be higher-resolution and requires more processing time.

The vehicle processor 212 can operate the sensing system 220 to detect an obstacle within the operating environment. In response to detecting the obstacle, the vehicle processor 212 can implement a collision avoidance operation to minimize, or prevent, a collision between the self-driving vehicle 110 and the detected obstacle. Examples of collision avoidance operations can include, but not limited to, controlling the drive system 230 to immediately stop the vehicle, cutting power to the vehicle motor, or avoidance steering.

The sensing system 220 can also include the sensing processor, in some embodiments, to assist with collision avoidance. For example, the sensing processor can receive data collected by the sensors to determine whether a collision is imminent and operate one or more collision avoidance operations. The sensing processor can include a low-level processor, such as a programmable logic controller (PLC). The sensing processor can receive and process low-level signals generated by the sensors, and in turn, can transmit low-level output logic signals to control the drive system 230 to implement a collision avoidance operation. With a low-level processor, the time required for detecting the collision can be improved to facilitate quick responses (in contrast to the vehicle processor 212, which is a more complex processor as it needs to execute instructions related to autonomous navigation and other operations).

The vehicle processor 212 of the self-driving vehicle 110 and/or the sensing processor of the sensing system 220 of the self-driving vehicle 110 can process in various ways the sensor data such as, for example, adjusting brightness of the sensor data, adjusting contrast of the sensor data, performing edge detection or edge finding using the sensor data, performing one or more morphological operations using the sensor data, generating and/or running one or more convolutional neural networks using the sensor data, generating and/or running one or more generalized pre-trained transformers using the sensor data, combinations of two or more thereof, etc. One or more outputs of such processing can be stored in one or more data stores (such as any data store described elsewhere herein, for example), can be used by the self-driving vehicle 110, can be used by another component of the system 100 (such as the fleet management system 120 or the data analysis system 150, for example), combinations of two or more thereof, etc. Different outputs of such processing can have, or include, differing degrees of abstraction.

The drive system 230 can include the components required for steering and driving the self-driving vehicle 110. For example, the drive system 230 can include a steering component and a drive motor.

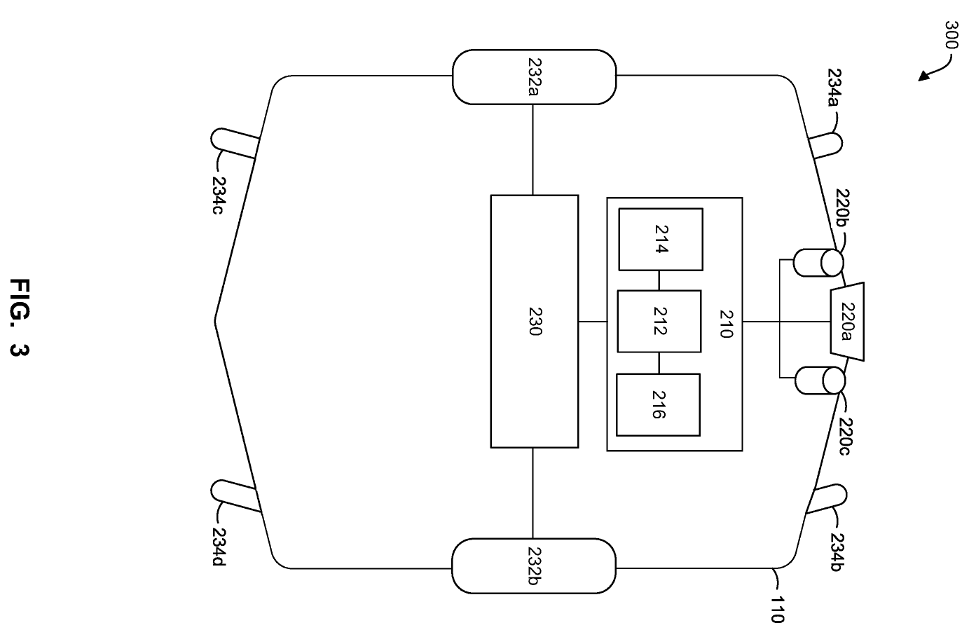

Reference will now be made to FIG. 3, which is another block diagram 300 of an example self-driving vehicle 110. The self-driving vehicle 110 includes the vehicle control system 210, the sensing system 220, and the drive system 230.

The drive system 230 can include a motor and/or brakes connected to drive wheels 232a and 232b for driving the self-driving vehicle 110. According to some embodiments, the motor may be an electric motor, a combustion engine, or a combination/hybrid thereof. In some embodiments, the drive system can include a battery for powering the motor. Depending on the particular embodiment, the drive system 230 may also include control interfaces that can be used for controlling the drive system 230. For example, the drive system 230 may be controlled to drive the drive wheel 232a at a different speed than the drive wheel 232b in order to turn the self-driving vehicle 110. Different embodiments may use different numbers of drive wheels, such as two, three, four, etc.

The drive system 230 can also include additional wheels 234a, 234b, 234c, and 234d (collectively referred herein as the wheels 234). Any or all of the additional wheels 234 may be wheels that are capable of allowing the self-driving vehicle 110 to turn, such as castors, steered wheels, and mecanum wheels.

The sensing system 220 can include a sensor 220a for detecting obstacles and optical sensors 220b, 220c. Example sensors 220a for detecting obstacles can include LIDAR devices or time-of-flight sensors. As shown in FIG. 3, the sensor 220a can be located at the front-end of the self-driving vehicle 110. At this location, the sensor 220a can scan for objects that may enter the path of the self-driving vehicle 110. More sensors 220a can be mounted to the self-driving vehicle 110, in some embodiments. The sensors 220a can be mounted to different locations, such as the front corner of the self-driving vehicle 110. Optical sensors 220b, 220c can include imaging and/or video cameras, mounted to a forward portion of the self-driving vehicle 110. According to some embodiments, the sensing system can include optical sensors arranged in a manner to provide three-dimensional (e.g. binocular or RGB-D) imaging.

The vehicle control system 210 can operate, at least, the drive system 230 and the sensing system 220 and can control and receive information from these components.

The positions of the components 210, 212, 214, 216, 220, 230, 232, and 234 of the self-driving vehicle 110 are shown for illustrative purposes and are not limited to the shown positions. Other configurations of the components 210, 212, 214, 216, 220, 230, 232, and 234 are possible.

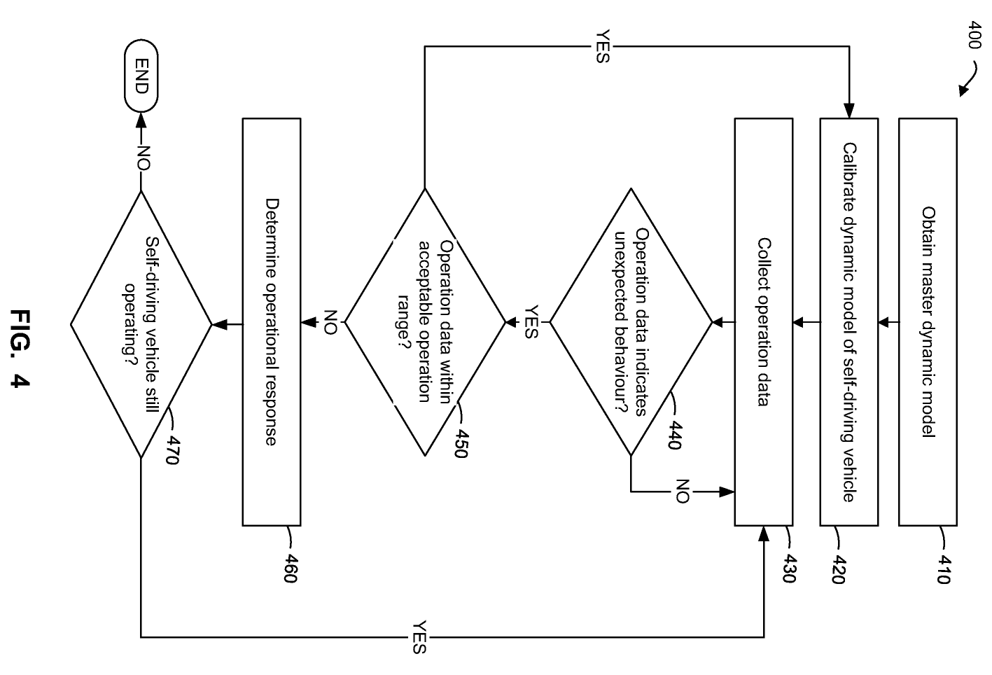

Referring to FIG. 4, there is shown an example method 400 for improving operation of a self-driving vehicle 110 based on continuous behavioural observation of the self-driving vehicle 110.

The method 400 begins at step 410, where the vehicle processor 212 of the self-driving vehicle 110 obtains a master dynamic model of the self-driving vehicle 110. For example, the vehicle processor 212 can obtain the master dynamic model of the self-driving vehicle 110 from the data analysis system 150 or the fleet management system 120 over the network 130. In some embodiments, the vehicle processor 212 obtains the master dynamic model of the self-driving vehicle 110 from the system data storage 140 over the network 130. In some embodiments, the vehicle processor 212 obtains the master dynamic model of the self-driving vehicle from the vehicle data storage 214.

The master dynamic model can be a model which represents expected behaviour of a representative “perfect” self-driving vehicle 110 (e.g. a version of the self-driving vehicle 110 which was perfectly manufactured and has no flaws). As such, the master dynamic model can be used to represent a nominal case for how a particular self-driving vehicle 110 should behave and/or perform. The master dynamic model (or any other model described herein) can be implemented in many different ways. For example, the master dynamic model can be implemented using one or more Newtonian models, Energy models (such as a model of system dynamics assuming Hamiltonian Mechanics, for example), parametric models, adaptive models, neural network models or other machine learning based models, etc. The master dynamic model can be generated from training data representing a “perfect” self-driving vehicle 110. The training data can, for example, be recorded during an initial product development phase of the self-driving vehicle 110.

In some embodiments, obtaining the master dynamic model includes the self-driving vehicle 110 obtaining data to generate the master dynamic model and then generating the master dynamic model. Data to generate the master dynamic model can, for example, be obtained from the system data storage 140 or vehicle data storage 214. One or more of the vehicle processor 212, the fleet management system 120 and the data analysis system 150 can then generate the master dynamic model from the obtained data.

In some embodiments, the self-driving vehicle 110 can obtain the master dynamic model from another self-driving vehicle 110.

A master dynamic model of the self-driving vehicle 110 can represent expected behaviour of one or more components of the self-driving vehicle 110. For example, the master dynamic model of the self-driving vehicle 110 can represent expected behaviour of one or more hardware components of the self-driving vehicle 110. Additionally, or alternatively, the master dynamic model of the self-driving vehicle 110 can represent expected behaviour of the self-driving vehicle 110 as a whole. In some embodiments, the master dynamic model of the self-driving vehicle 110 includes a plurality of models.

In some embodiments, the master dynamic model of the self-driving vehicle 110 includes, or is, a model of a motor of the self-driving vehicle 110 (such as a motor of the drive system 230 of the self-driving vehicle 110, for example). The model of the motor of the self-driving vehicle 110 can represent an expected behaviour of the motor of the self-driving vehicle 110. For example, the model of the motor of the self-driving vehicle 110 can represent an expected thermal behaviour of the motor, expected current consumption of the motor, an expected response time of the motor, expected vibration of the motor, expected stiction of the motor, combinations of two or more thereof, etc.

In some embodiments, the master dynamic model of the self-driving vehicle 110 includes, or is, a model of an actuator of the self-driving vehicle 110 such as a brake of the self-driving vehicle 110, a relay of the self-driving vehicle 110, etc. The model of the actuator of the self-driving vehicle 110 can represent an expected behaviour of the actuator (such as a brake, a relay, etc., for example). For example, the model of the actuator of the self-driving vehicle 110 can represent an expected cycle count of the actuator, an expected response time of the actuator, both an expected cycle count of the actuator and an expected response time of the actuator, etc.

In some embodiments, the master dynamic model of the self-driving vehicle 110 includes, or is, a model of a battery of the self-driving vehicle 110. The model of the battery of the self-driving vehicle can represent an expected behaviour of the battery of the self-driving vehicle 110. For example, the model of the battery of the self-driving vehicle 110 can represent an expected state of health of the battery, expected charging cycles of the battery, an expected discharging time of the battery, an expected charging time of the battery, expected automatic state of charge balancing, combinations of two or more thereof, etc.

In some embodiments, the master dynamic model of the self-driving vehicle 110 includes, or is, a model of the self-driving vehicle’s dynamics. The model of the dynamics can be used to predict how the self-driving vehicle 110 will accelerate, for example, as a function of historical joint positions, velocities and commands given the self-driving vehicle’s geometry. The predicted values can then be compared to measured accelerations (such as from joint odometry, visual odometry, etc., for example). Sudden differences between a predicted acceleration and measured acceleration can be used to identify changes in operating conditions (such as payload falling off of the self-driving vehicle 110, mechanical interference like a rock getting stuck in the drivetrain of the self-driving vehicle 110, etc., for example). Long-term differences between predicted acceleration and measured acceleration can be used to identify system wear (such as due to increasing gearbox friction, motors producing less torque, components rubbing on each other, etc., for example).

In some embodiments, the master dynamic model of the self-driving vehicle 110 includes, or is, an odometry model. The odometry model can be used to predict how far the self-driving vehicle 110 has travelled based on sensor measurements (such as wheel odometry from wheel-based encoders, laser odometry from LIDARs, visual odometry from cameras, etc., for example). An odometry model may be generated for each type of odometry sensor (such as a first model for wheel odometry and a second model for laser odometry, for example). In some embodiments, a single odometry model is generated for a plurality of different types of odometry sensors. Data from the plurality of different types of odometry sensors can be combined or fused together into the single odometry model such as, for example, by using a Kalman filter. Predicted values from one odometry model can be compared to the other odometry models. Sudden differences between odometry models can be used to identify sensor damage/failure (such as a wheel-based encoder detaching, a LIDAR having taken a physical hit, etc., for example). Long-term differences between odometry models can be used to identify losses in calibration or component wear (such as cameras being vibrated out of calibration, wheel wear, etc., for example).

Variations in components of the self-driving vehicles 110 and/or manufacturing processes used to manufacture each of the self-driving vehicles 110 can cause each self- driving vehicle 110 to perform slightly differently. At step 420, the vehicle processor 212 calibrates the master dynamic model of the self-driving vehicle 110 based on actual performance of the self-driving vehicle 110. For example, the vehicle processor 212 can adapt, based on vehicle data associated with operation of the self-driving vehicle 110 collected during an initial observation period of the self-driving vehicle 110, the master dynamic model into a vehicle dynamic model specific to the self-driving vehicle 110. The vehicle dynamic model can then represent expected behaviour of the specific self-driving vehicle 110. The initial observation period can, for example, be an initial burn-in time of the self-driving vehicle 110 once the self-driving vehicle 110 has come off an assembly line or a requalification time after the self-driving vehicle 110 has undergone major servicing. The vehicle dynamic model can represent sensor calibrations specific to the self-driving vehicle 110.

The vehicle data can represent current performance of a component of the self-driving vehicle 110 or performance generally of the self-driving vehicle 110 (such as acceleration, motor response, braking response, etc., for example). Any sensor of the sensing system 220 or the self-driving vehicle 110 can, for example, collect the vehicle data. In some embodiments, one or more calibration or testing sequences are performed to collect the vehicle data.

By adapting the master dynamic model to generate the vehicle dynamic model specific to the self-driving vehicle 110 rather than generating a new model for the self-driving vehicle 110, the amount of training data required to generate the model can advantageously be reduced.

At step 430, the vehicle processor 212 of the self-driving vehicle 110 collects, during the operation of the self-driving vehicle 110, operation data associated with the operation of the self-driving vehicle 110. The operation data can be collected from a variety of sources and can include any data related to the operating state of the self-driving vehicle 110.

The operation data includes data related to the self-driving vehicle 110 itself. The vehicle processor 212 can collect vehicle data from the sensing system 220. For example, the vehicle processor 212 can collect data regarding the temperature, supplied current, supplied voltage, velocity, or acceleration of one or more components of the drive system 230. The vehicle processor 212 may also collect vehicle data directly from the components and subcomponents of the self-driving vehicle 110. For example, the vehicle processor 212 can collect log files, command signals, messages, and other data from the drive system 230 or control system 210. The log files and other data may contain various information related to autonomous navigation of the self-driving vehicle 110 and other operations of the self-driving vehicle 110.

The operation data may also include data related to the environment of the self-driving vehicle 110. The vehicle processor 212 may operate the sensing system 220 to collect the data related to the environment of the self-driving vehicle.

At step 440, the vehicle processor 212 of the self-driving vehicle 110 determines whether the collected operation data is indicative of an unexpected behaviour of the self-driving vehicle 110 in relation to the expected individual behaviour of the self-driving vehicle 110 as defined by the vehicle dynamic model of the self-driving vehicle 110. An unexpected behaviour is any behaviour of the self-driving vehicle 110 which is not as expected. For example, the self-driving vehicle 110 can compare a measured value of acceleration of the self-driving vehicle 110 against an expected value of acceleration of the self-driving vehicle 110 determined from the dynamic model of the self-driving vehicle 110. If the self-driving vehicle 110 is accelerating slower or faster than expected, the acceleration of the self-driving vehicle 110 would be an unexpected behaviour of the self-driving vehicle. As another example, the self-driving vehicle 110 can compare a measured turning rate of the self-driving vehicle 110 against an expected turning rate of the self-driving vehicle 110 determined from the dynamic model of the self-driving vehicle 110. If the self-driving vehicle 110 is turning more or less than expected, the turning rate of the self-driving vehicle 110 would be an unexpected behaviour. An unexpected behaviour of the self-driving vehicle 110 can indicate that at least one component of the self-driving vehicle 110 has degraded, has malfunctioned or is about to malfunction.

If the collected operation data is not indicative of an unexpected behaviour of the self-driving vehicle 110, the method 400 can return to step 430. However, if the collected operation data is indicative of an unexpected behaviour of the self-driving vehicle, then the method 400 can proceed to step 450.

At step 450, the vehicle processor 212 of the self-driving vehicle 110 determines whether the unexpected behaviour is within an acceptable operation range. An acceptable operation range (or tolerance limit) can be determined for each behaviour of the self-driving vehicle. The acceptable operation range can be an amount by which a behaviour of the self-driving vehicle is allowed to deviate from the expected (or nominal) behaviour. Different behaviours can have different acceptable operation ranges. For example, a safety critical behaviour of the self-driving vehicle can have a much smaller acceptable operation range than a non-safety critical behaviour. The acceptable operation range(s) can, for example, be determined by the vehicle processor 212 of the self-driving vehicle 110, the fleet management system 120, the data analysis system 150, combinations of two or more thereof, etc.

Model tolerances or acceptable operational ranges can demark maximum deviations from the nominal case (the model’s predicted behaviour), beyond which the self-driving vehicle 110 should adjust its behaviour and/or the user/operator should perform some kind of maintenance on the self-driving vehicle 110. In an extreme case, the most critical tolerance limits could be used as indicators that the self-driving vehicle 110 can no longer safely operate.

For a model which represents dynamics of the self-driving vehicle 110, tolerance values can be set for, for example, the self-driving vehicle’s ability to slow down (decelerate), the self-driving vehicle’s ability to speed up (accelerate), the self-driving vehicle’s ability to trade linear velocity for angular velocity and vice versa (maneuverability), the self-driving vehicle’s maximum achievable linear and angular velocities, an amount of G-shock, combinations of two or more thereof, etc.

In an example case, G-shock data may be collected (such as with an IMU, for example) during tuning of the self-driving vehicle 110 on a shakedown course. The shakedown course may be set to determine a maximum G-shock on the self-driving vehicle 110. A tolerance-limit for G-shock may be set based on the calibration performed from the shakedown course. Operation data indicating G-shock outside of the tolerance-limit (or acceptable operation range) may result in an operational response as described elsewhere herein.

For a model which represents odometry of the self-driving vehicle 110, tolerance values can be set for, for example, a sensor’s individual calibration (e.g., to determine if a camera is out of focus), a sensor’s position/orientation relative to the vehicle (e.g., to determine if lidar is twisted), an odometry model’s output relative to an output of another available odometry model, combinations of two or more thereof, etc.

If the unexpected behaviour of the self-driving vehicle 110 is within the acceptable operation range (e.g. the self-driving vehicle 110 is operating as expected when tolerances are accounted for), the method 400 can return to step 420 where the vehicle processor 212 of the self-driving vehicle 110 updates (or calibrates) the vehicle dynamic model of the self-driving vehicle 110 based on the operation data collected at step 430. Updating the vehicle dynamic model of the self-driving vehicle 110 updates the vehicle dynamic model of the self-driving vehicle 110 for the vehicle dynamic model to better represent the current state of the self-driving vehicle 110. Updating the vehicle dynamic model of the self-driving vehicle 110 can include the vehicle processor 212 of the self-driving vehicle 212 incorporating the operation data collected at step 430 into the vehicle dynamic model of the self-driving vehicle 110. Updating the vehicle dynamic model of the self-driving vehicle 110 can, for example, at least partially account for performance degradation of the self-driving vehicle 110 over time.

If the unexpected behaviour of the self-driving vehicle 110 is not within the acceptable operation range (e.g. the self-driving vehicle 110 is not operating as expected when tolerances are accounted for), method 400 can proceed to step 460.

At step 460, the vehicle processor 212 of the self-driving vehicle 110 determines an operational response to the unexpected behaviour. As described elsewhere herein, the operational response may vary depending on the severity of the unexpected behaviour. The operational response can include any response from continuing to operate the self-driving vehicle 110 with no change to immediately ceasing operation of the self-driving vehicle 110.

As described elsewhere herein, the self-driving vehicle’s response to a detected unexpected behaviour (or loss of performance) can be tailored to the degree of severity of the unexpected behaviour (or performance loss). For example, a small loss of performance might prompt the self-driving vehicle 110 (or the vehicle processor 212 of the self-driving vehicle 110) to use a degraded performance profile – reducing maximum speed to limit vibration/shock, limiting acceleration to reduce the torque demands on the drivetrain or limiting power to reduce thermal load(s) on the self-driving vehicle 110, for example. A major loss of performance can conversely cause the self-driving vehicle 110 to immediately cease operation (such as due to a sudden discrepancy in laser odometry which indicates an issue with the lidars (a safety sensor), for example). Some losses of performance of the self-driving vehicle 110 can cause the self-driving vehicle 110 to use or run a performance profile which does not allow for autonomous operation of the self-driving vehicle 110 but can still allow for manual operation of the self-driving vehicle 110 by a user/operator (such as by teleoperation of the self-driving vehicle 110, for example).

In some embodiments, the operational response includes the self-driving vehicle 110 (or the vehicle processor 212 of the self-driving vehicle 110) calibrating the unexpected behaviour to be within the acceptable operation range. In some embodiments, calibrating the unexpected behaviour to be within the acceptable operation range includes the self-driving vehicle 110 (or the vehicle processor 212 of the self-driving vehicle 110) reconfiguring at least a first component of the self-driving vehicle 110 to perform at least one operation previously performed by a second component of the self-driving vehicle 110 and causing the second component of the self-driving vehicle 110 to cease performance of the at least one operation. In some embodiments, calibrating the unexpected behaviour to be within the acceptable operation range includes the self-driving vehicle 110 (or the vehicle processor 212 of the self-driving vehicle 110) limiting performance of at least one operation of the self-driving vehicle 110 until the unexpected behaviour is within the acceptable operation range.

At step 470, the vehicle processor 212 can determine if the self-driving vehicle 110 is still in operation. For example, if the operational response determined at step 460 shut down the self-driving vehicle 110, the self-driving vehicle 110 is no longer in operation and the method 400 can end. On the other hand, if the self-driving vehicle 110 is still in operation, the method 400 can return to step 430.

In some embodiments, operation data is collected (e.g. step 430) continuously. In some embodiments, operation data is collected (e.g. step 430) periodically (and/or the self-driving vehicle 110 (or the vehicle processor 212 of the self-driving vehicle 110) is periodically caused to determine whether the operation data is indicative of the unexpected behaviour). In some embodiments, operation data is collected (e.g. step 430) in response to a trigger event as described elsewhere herein.

Although in method 400 the vehicle processor 212 of the self-driving vehicle 110 obtains the master dynamic model of the self-driving vehicle 110 and generates a vehicle dynamic model specific, or individualized, to the self-driving vehicle 110 any computing device may be caused to generate the vehicle dynamic model specific to the self-driving vehicle 110. For example, the fleet management system 120 or the data analysis system 150 may be caused to generate a vehicle dynamic model specific to the self-driving vehicle 110.

The operation data collected by the self-driving vehicle 110 may include environment data associated with an environment through which the self-driving vehicle 110 is operating. For example, a floor (or surface) condition may play a critical role in determining how a self-driving vehicle 110 should operate to ensure safety, reliability and/or longevity. Differing environments and/or environmental conditions may vary and/or may impact performance of the self-driving vehicle 110. The self-driving vehicle determining and/or monitoring the environment and/or environmental conditions and their impacts on performance of the self-driving vehicle 110 may therefore be advantageous.

The self-driving vehicle 110 may detect presence of dust, dirt, grease, liquid, etc. on a floor (or surface that the self-driving vehicle 110 is travelling across) by, for example, detecting one or more of the following:

consistently low- or medium-impact traction loss (which may be detected, for example, by analysis of wheel slip, a mismatch between wheel odometry data and IMU odometry data, etc.);

higher electrical current being required to be supplied to one or more motors of the self-driving vehicle 110 (e.g., to compensate for lost grip);

frequent correction being required for wheel encoder odometry data;

an extended stopping distance compared to a baseline stopping distance.

The self-driving vehicle 110 may detect presence of a highly polished surface across which the self-driving vehicle 110 is traveling by, for example, detecting one or more of the following:

a sudden high-impact traction loss or wheel lock (which may be detected, for example, by detecting a mismatch between wheel odometry data and IMU odometry data, etc.);

a sudden correction being required for wheel encoder odometry data;

an extended stopping distance compared to a baseline stopping distance.

The self-driving vehicle 110 may detect presence of cracks, gaps, steps, etc. in a floor (or other surface) across which the self-driving vehicle 110 is traveling across by, for example, detecting one or more of the following:

spikes in IMU data (e.g., which may indicate that the self-driving vehicle 110 is traversing gaps or encountering steps);

increased vibration of a body of the self-driving vehicle 110 especially at high speed.

The self-driving vehicle 110 may detect external blocking or floor/surface step resistance by, for example, detecting one or more of the following:

indicators on wheels of the self-driving vehicle 110 indicating external blocking or floor/surface step resistance;

a drive command being active but wheel encoder feedback showing little or no rotation;

motor current consumption spikes indicating torque resistance without a change in movement;

elevated motor temperature (e.g. caused by repeated torque application without movement).

In some embodiments, the operation data collected by the self-driving vehicle 110 includes physical condition data. The physical condition data may be associated with a physical condition of the self-driving vehicle 110.

In some embodiments, the physical condition data includes drivetrain data associated with a state of a drivetrain of the self-driving vehicle 110. Drivetrain issues may, for example, reduce efficiency, increase overheating risks or compromise motion precision over time.

The self-driving vehicle 110 may detect degradation of one or more motors of the self-driving vehicle 110 by, for example, detecting one or more of the following:

increased electrical current consumption compared to baseline operation under similar load and floor/surface conditions;

delayed acceleration or deceleration response (e.g. may indicate motor torque build-up is slower than expected);

a delayed motor response;

an uncharacteristic or unexpected motor response;

jitter in motor response;

noise in motor response;

an inability of self-driving vehicle 110 to reach maximum speed;

an unexpected steering motor response;

drifting or uneven wheel behaviour between left and right during straight motion of the self-driving vehicle 110.

The self-driving vehicle 110 may detect an obstructed wheel of the self-driving vehicle 110 by, for example, detecting one or more of the following:

a drive command being active but wheel encoder feedback showing little or no rotation;

motor current consumption spikes indicating torque resistance without a change in movement;

elevated motor temperature (e.g. which may be caused by repeated torque application without movement);

drifting of the self-driving vehicle 110 during straight motion.

The self-driving vehicle 110 may detect wheel encoder contamination or degradation by, for example, detecting one or more of the following:

fluctuating or noisy encoder readings not matching an expected motion behaviour;

redundant wheel encoder feedback mismatch;

one or more abnormal wheel encoder signal patterns (e.g., skipped counts or signal drop).

The self-driving vehicle 110 may detect damage or wear of one or more brakes of the self-driving vehicle 110 by, for example, detecting one or more of the following:

increased brake engagement time where mechanical parts take longer to activate;

an extended stopping distance compared to a normal stopping distance (e.g., during normal operation on typical floor that the self-driving vehicle 110 is used on);

inconsistent braking response across stop events.

In some embodiments, the physical condition data includes battery data associated with a state of a battery of the self-driving vehicle 110. Battery issues may, for example, reduce operation uptime, increase charge cycles or increase risk of accelerated wear or thermal issues.

The self-driving vehicle 110 may detect module degradation (State of Health) of one or more batteries of the self-driving vehicle 110 by, for example, detecting one or more of the following:

reduced discharge duration where a battery drains faster than an expected runtime under similar operation conditions;

an extended charging time (e.g., especially when calibrating imbalanced cells);

a lower peak voltage at full charge;

uneven current consumption compared to other modules in the same batter pack (e.g., may indicate load imbalance or internal resistance issues);

faster temperature rise under load or charging.

The self-driving vehicle 110 may detect a damaged or disconnected module of one or more batteries of the self-driving vehicle 110 by, for example, detecting one or more of the following:

loss of communication with one or more individual modules of a battery (e.g., may result from hardware failure, connection issues, bus instability, etc.);

a lower pack voltage of a battery (e.g., may indicate one or more dead modules/cells).

The self-driving vehicle 110 may detect degraded cells of one or more batteries of the self-driving vehicle 110 by, for example, detecting one or more of the following:

sudden voltage drops under load;

cell voltage lags during charging.

In some embodiments, the physical condition data includes payload data associated with a state of a payload of the self-driving vehicle 110. Payload may, for example, directly impact a center of gravity, driving stability or safety of the self-driving vehicle 110.

The self-driving vehicle 110 may detect an overweight payload by, for example, detecting one or more of the following:

increased motor consumption during normal driving as more torque is required to maintain the same velocity or overcome inertia;

reduced deceleration (e.g., as detected by an IMU) compared to a baseline deceleration indicating more force required to stop the self-driving vehicle 110;

reduced acceleration (e.g., as detected by an IMU) compared to a baseline acceleration;

a longer stopping distance than a baseline for a given floor/surface condition.

The self-driving vehicle 110 may detect that the self-driving vehicle 110 is outside of the center of gravity allowable limits by, for example, detecting one or more of the following:

tilting, uneven wheel load or drifting during normal straight movement of the self-driving vehicle 110;

an uneven turning radius or wheel slippage on one side of the self-driving vehicle 110;

uneven electrical current consumption or thermal behaviour on one wheel of the self-driving vehicle 110.

In some embodiments, the operation data includes data related to an amount of electrical current being drawn by one or more motors of the self-driving vehicle 110. An expected amount of electrical current being drawn by the one or more motors of the self-driving vehicle 110 may be modeled as described elsewhere herein. The operation data related to the amount of electrical current being drawn by one or more motors of the self-driving vehicle 110 may be compared against the expected amount of electrical current that is to be drawn by the one or more motors of the self-driving vehicle 110 to determine whether an unexpected behaviour of the self-driving vehicle 110 has occurred as described elsewhere herein.

The data related to an amount of electrical current being drawn by one or more motors of the self-driving vehicle 110 may be collected from or may include data related to one or more of the following subsystems of the self-driving vehicle 110: a power supply of the self-driving vehicle 110, one or more motor controllers of the self-driving vehicle 110, one or more motors of the self-driving vehicle 110, a drivetrain of the self-driving vehicle 110, one or more wheel encoders of the self-driving vehicle 110, etc. A model of expected electrical current being drawn by one or more motors of the self-driving vehicle 110 may be based on or may include one or more models of the following subsystems of the self-driving vehicle 110: a power supply of the self-driving vehicle 110, one or more motor controllers of the self-driving vehicle 110, one or more motors of the self-driving vehicle 110, a drivetrain of the self-driving vehicle 110, one or more wheel encoders of the self-driving vehicle 110, etc.

If an electrical current being drawn by a motor of the self-driving vehicle 110 is detected to be suddenly lower than predicted (or expected) for one or more given (or provided) motor commands, then, for example, a motor or drivetrain of the self-driving vehicle 110 may be sheared, an unexpected loss of a payload of the self-driving vehicle 110 may have occurred or an unexpected loss of ground contact may have occurred. A motor command may, for example, be provided by a processor or controller of the self-driving vehicle 110.

If an electrical current being drawn by a motor of the self-driving vehicle 110 is detected to be consistently lower than predicted (or expected) for one or more given (or provided) motor commands, then, for example, an internal resistance of a motor of the self-driving vehicle 110 may be high (e.g., as a result of a gapped wire), a power supply of the self-driving vehicle 110 may be unable to maintain voltage or one or more motor controllers of the self-driving vehicle 110 may be misconfigured.

If an electrical current being drawn by a motor of the self-driving vehicle 110 is detected to be suddenly higher than predicted (or expected) for one or more given (or provided) motor commands, then, for example, a motor or drivetrain of the self-driving vehicle 110 may be seized, an unexpected increase in a payload of the self-driving vehicle 110 may have occurred or an unexpected collision with one or more objects may have occurred.

If an electrical current being drawn by a motor of the self-driving vehicle 110 is detected to be consistently higher than predicted (or expected) for one or more given (or provided) motor commands, then, for example, an internal resistance of a motor of the self-driving vehicle 110 may be low (e.g., as a result of a shorted wire), a drivetrain of the self-driving vehicle 110 may be damaged or one or more motor controllers of the self-driving vehicle 110 may be misconfigured.

If an electrical current being drawn by a motor of the self-driving vehicle 110 includes unexpected spikes or valleys (or unexpected maximums or minimums), then, for example, the self-driving vehicle 110 may be traversing unexpectedly rougher terrain (e.g., which includes unexpected ledges, cracks, etc.), debris may be caught in a drivetrain of the self-driving vehicle 110 or a drivetrain of the self-driving vehicle 110 may be damaged.

In some embodiments, the operation data includes data related to an acceleration or deceleration of the self-driving vehicle 110. An expected acceleration or deceleration of the self-driving vehicle 110 may be modeled as described elsewhere herein. The operation data related to the acceleration or deceleration of the self-driving vehicle 110 may be compared against the expected acceleration or deceleration of the self-driving vehicle 110 to determine whether an unexpected behaviour of the self-driving vehicle 110 has occurred as described elsewhere herein.

The data related to an acceleration or deceleration of the self-driving vehicle 110 may be collected from or may include data related to one or more of the following subsystems of the self-driving vehicle 110: one or more motor controllers of the self-driving vehicle 110, one or more motors of the self-driving vehicle 110, a drivetrain of the self-driving vehicle 110, one or more wheel encoders of the self-driving vehicle 110, one or more IMUs of the self-driving vehicle 110, one or more LIDARs of the self-driving vehicle 110, one or more cameras of the self-driving vehicle 110, etc. A model of expected acceleration or deceleration of the self-driving vehicle 110 may be based on or may include one or more models of the following subsystems of the self-driving vehicle 110: one or more motor controllers of the self-driving vehicle 110, one or more motors of the self-driving vehicle 110, a drivetrain of the self-driving vehicle 110, one or more wheel encoders of the self-driving vehicle 110, one or more IMUs of the self-driving vehicle 110, one or more LIDARs of the self-driving vehicle 110, one or more cameras of the self-driving vehicle 110, etc.

If an acceleration of the self-driving vehicle 110 is detected to be suddenly lower than predicted (or expected) for one or more given (or provided) motor commands and a deceleration of the self-driving vehicle 110 is detected to be suddenly higher than predicted (or expected) for one or more given (or provided) motor commands, then, for example, the self-driving vehicle 110 may be traversing over unexpectedly rough terrain, the self-driving vehicle 110 may need to traverse an unexpected step-up in terrain or the self-driving vehicle 110 may have had an unexpected collision with one or more objects.

If an acceleration of the self-driving vehicle 110 is detected to be consistently lower than predicted (or expected) for one or more given (or provided) motor commands and a deceleration of the self-driving vehicle 110 is detected to be consistently higher than predicted (or expected) for one or more given (or provided) motor commands, then, for example, a drivetrain of the self-driving vehicle 110 may be damaged (e.g., resulting in increased friction between components of the drivetrain) or there may be a friction point between the self-driving vehicle 110 and the environment the self-driving vehicle 110 is travelling through.

If both an acceleration and a deceleration of the self-driving vehicle 110 are detected to be lower than predicted (or expected) for one or more given (or provided) motor commands, then, for example, a payload of the self-driving vehicle 110 may have increased, the self-driving vehicle 110 may be unexpectedly traversing slip terrain (e.g., sand, gravel, oil, etc.) or the self-driving vehicle 110 may be experiencing a loss of traction.

If an acceleration or deceleration of one wheel of the self-driving vehicle 110 is detected to suddenly deviate from an acceleration or deceleration of another wheel of the self-driving vehicle 110, then, for example, a payload of the self-driving vehicle 110 may have shifted or toppled.

In some embodiments, the operation data includes data related to an odometry of the self-driving vehicle 110. An expected odometry of the self-driving vehicle 110 may be modeled as described elsewhere herein. The operation data related to the odometry of the self-driving vehicle 110 may be compared against the expected odometry of the self-driving vehicle 110 to determine whether an unexpected behaviour of the self-driving vehicle 110 has occurred as described elsewhere herein.

The data related to an odometry of the self-driving vehicle 110 may be collected from or may include data related to one or more of the following subsystems of the self-driving vehicle 110: one or more wheel encoders of the self-driving vehicle 110, one or more IMUs of the self-driving vehicle 110, one or more LIDARs of the self-driving vehicle 110, one or more cameras of the self-driving vehicle 110, etc. A model of expected odometry of the self-driving vehicle 110 may be based on or may include one or more models of the following subsystems of the self-driving vehicle 110: one or more wheel encoders of the self-driving vehicle 110, one or more IMUs of the self-driving vehicle 110, one or more LIDARs of the self-driving vehicle 110, one or more cameras of the self-driving vehicle 110, etc.

If an odometry of the self-driving vehicle 110 detected by one or more sensors or sub-systems of the self-driving vehicle 110 does not match an expected odometry of the self-driving vehicle 110 then, for example, the self-driving vehicle 110 may be experiencing unexpected wheel slip or the self-driving vehicle 110 may be surrounded by one or more moving objects that are blocking a view of the self-driving vehicle 110 to one or more fixed reference objects.

In some embodiments, the operation data includes data related to a power usage of the self-driving vehicle 110. An expected power usage of the self-driving vehicle 110 may be modeled as described elsewhere herein. The operation data related to the power usage of the self-driving vehicle 110 may be compared against the expected power usage of the self-driving vehicle 110 to determine whether an unexpected behaviour of the self-driving vehicle 110 has occurred as described elsewhere herein.

The data related to a power usage of the self-driving vehicle 110 may be collected from or may include data related to one or more of the following subsystems of the self-driving vehicle 110: a power system of the self-driving vehicle 110, one or more processors, controllers or computer systems of the self-driving vehicle 110, one or more motors of the self-driving vehicle 110, etc. A model of expected power usage of the self-driving vehicle 110 may be based on or may include one or more models of the following subsystems of the self-driving vehicle 110: a power system of the self-driving vehicle 110, one or more processors, controllers or computer systems of the self-driving vehicle 110, one or more motors of the self-driving vehicle 110, etc.

If a detected voltage level of a power system of the self-driving vehicle 110 suddenly drops faster than expected for a given draw of a computer system of the self-driving vehicle 110 and a given draw of one or more motors of the self-driving vehicle 110, then, for example, an electrical system fault may have occurred (e.g., shorting or arcing) or one or more motors of fans of the self-driving vehicle 110 may have stalled (e.g., thereby drawing more current).

If a detected voltage level of a power system of the self-driving vehicle 110 consistently drops faster than expected for a given draw of a computer system of the self-driving vehicle 110 and a given draw of one or more motors of the self-driving vehicle 110, then, for example, one or more batteries of the self-driving vehicle 110 may be damaged or worn thereby resulting in reduced capacity.

In some embodiments, the operation data includes visual data. An expected visibility of the self-driving vehicle 110 may be modeled as described elsewhere herein. The operation data related to the visibility of the self-driving vehicle 110 may be compared against the expected visibility of the self-driving vehicle 110 to determine whether an unexpected behaviour of the self-driving vehicle 110 has occurred as described elsewhere herein.

The visual data may be collected from or may include data related to one or more of the following subsystems of the self-driving vehicle 110: one or more LIDARs of the self-driving vehicle 110, one or more cameras of the self-driving vehicle 110, etc. A model of visibility of the self-driving vehicle 110 may be based on or may include one or more models of the following subsystems of the self-driving vehicle 110: one or more LIDARs of the self-driving vehicle 110, one or more cameras of the self-driving vehicle 110, etc.

If a detected range of one or more LIDARs of the self-driving vehicle 110 is consistently shorter than a range predicted by data from one or more cameras of the self-driving vehicle 110, then, for example, the one or more LIDARs of the self-driving vehicle 110 may be experiencing blinding or saturation.

In some embodiments, a model described herein is static (e.g., unchanging from when the self-driving vehicle 110 was constructed or a major maintenance/update was performed). In some embodiments, as described elsewhere herein, a model described herein is dynamic (e.g., is updated/adjusted over the course of the lifetime of the self-driving vehicle 110 as the self-driving vehicle 110 is operating). If a model is dynamic, a deviation of a current version of the model may be compared against an original version of the model to, for example, track wear/tear of the self-driving vehicle 110 or a component (or components) of the self-driving vehicle 110.

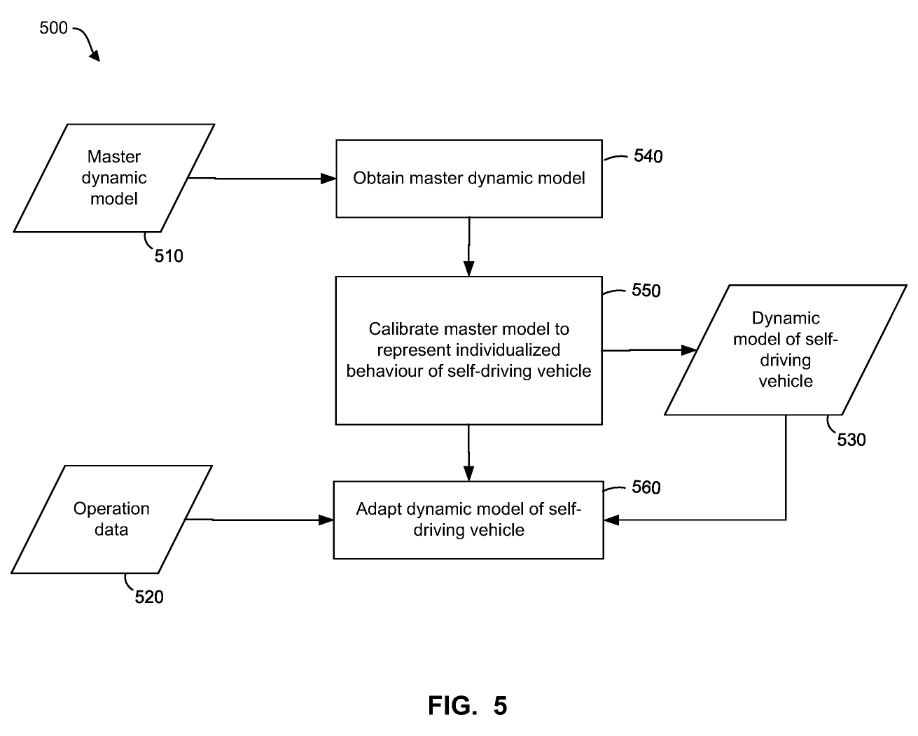

Referring to FIG. 5, there is now shown an example method 500 for generating a vehicle dynamic model specific to, or individualized to, a self-driving vehicle 110.

The method 500 begins at step 540, where a computing device obtains a master dynamic model 510 of the self-driving vehicle 110. The computing device can, for example, obtain the master dynamic model 510 from a data store such as the system data storage 140.

At step 550, the computing device calibrates (or adapts) the master dynamic model 510 into a dynamic model 530 of the self-driving vehicle 110. The dynamic model 530 is specific to, or individualized to, the self-driving vehicle 110 as described elsewhere herein.

At step 560, the computing device adapts the dynamic model 530 of the self-driving vehicle 110 in view of operation data 520 which is associated with the operation of the self-driving vehicle 110 and is collected during the operation of the self-driving vehicle 110. The operation data 520 can include, or be like, any of the operation data described elsewhere herein.

The dynamic model 530 of the self-driving vehicle 110 generated by the computing device can be provided to the self-driving vehicle 110 (such as over the network 130, for example). In some embodiments, the fleet management system 120 or the data analysis system 150 generate the dynamic model 530 and adapt the dynamic model 530 based on the operation data 520 collected by the self-driving vehicle 110 and sent to the fleet management system 120 or the data analysis system 150 over the network 130.

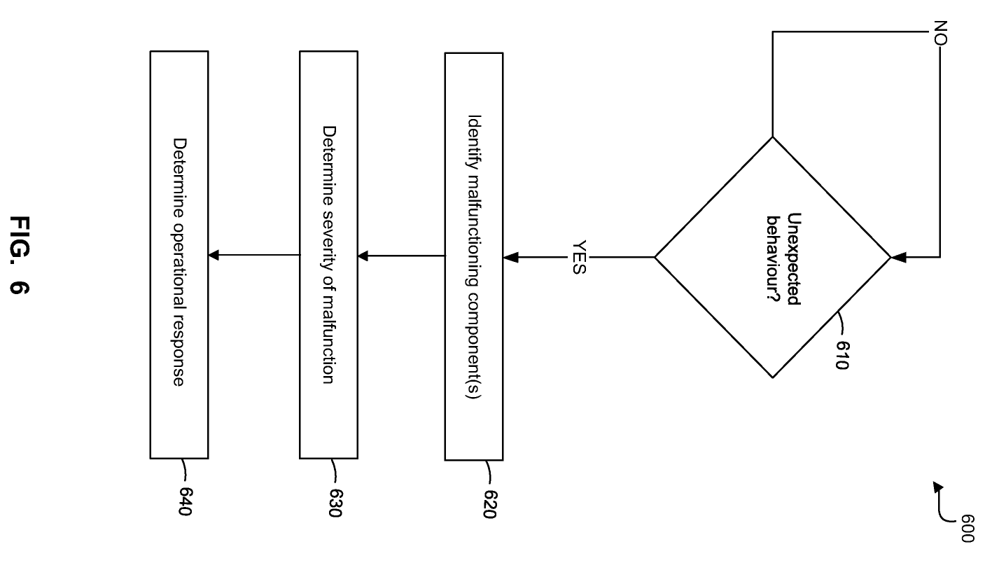

Referring to FIG. 6, there is now shown an example method 600 for determining an operational response to an unexpected behaviour (or behaviours) of the self-driving vehicle 110 being detected.

The method 600 begins at step 610, where the vehicle processor 212 of the self-driving vehicle 110 determines whether an unexpected behaviour has occurred. An unexpected behaviour can, for example, occur if the collected operation data is outside of an acceptable operation range as described elsewhere herein. If an unexpected behaviour is not detected, the method 600 can remain at step 610. If however an unexpected behaviour is detected, the method 600 can proceed to step 620.

At step 620, the vehicle processor 212 of the self-driving vehicle 110 determines (or identifies) which component(s) of the self-driving vehicle 110 have malfunctioned. For example, the vehicle processor 212 of the self-driving vehicle 110 can identify which component(s) caused the unexpected behaviour to identify the malfunctioning component(s).

A motor of the self-driving vehicle 110 can experience thermal stress. For example, a motor of the self-driving vehicle 110 can overheat. The overheating (or thermal stress more generally) may, for example, be caused by high torque output of the motor, the self-driving vehicle 110 having to travel across one or more steep inclines, frequent acceleration of the self-driving vehicle 110, etc.

A battery of the self-driving vehicle 110 can experience thermal stress. For example, a battery of the self-driving vehicle 110 can overheat due to, for example, high current draw during demanding operations (such as fast acceleration or heavy loads, for example).

Additionally, or alternatively, a battery of the self-driving vehicle 110 can experience stress due to an imbalanced state of charge (SoC) of the battery. For example, a battery of the self-driving vehicle 110 can experience an imbalanced state of charge (SoC) when some cells of the battery discharge faster than other cells thereby reducing efficiency and capacity of the battery.

Additionally, or alternatively, a battery of the self-driving vehicle 110 can experience stress due to a low state of charge (SoC) of the battery. For example, operating a self-driving vehicle 110 which includes a battery having a low state of charge (SoC) can increase risk of sudden shutdowns of the self-driving vehicle 110 and/or prevent completion of a mission of the self-driving vehicle 110.

At step 630, the vehicle processor 212 of the self-driving vehicle 110 determines a severity of the identified malfunction. For example, a malfunction of a critical system may require immediate shut down of the self-driving vehicle 110 whereas the self-driving vehicle 110 may be able to continue to operate if the identified malfunction is of a non-critical system (such as a system which adds only aesthetic value to the self-driving system 110, for example).

At step 640, the vehicle processor 212 of the self-driving vehicle 110 determines an operational response to the identified malfunction.

In response to thermal stress of a motor, the self-driving vehicle 110 (or the vehicle processor 212 of the self-driving vehicle 110) can limit a top speed of the self-driving vehicle 110 to decrease energy dissipation. Additionally, or alternatively, in response to thermal stress of a motor, the self-driving vehicle 110 (or the vehicle processor 212 of the self-driving vehicle 110) can limit acceleration of the self-driving vehicle 110 to decrease energy dissipation. Additionally, or alternatively, in response to thermal stress of a motor, the self-driving vehicle 110 (or the vehicle processor 212 of the self-driving vehicle 110) can optimize a route of the self-driving vehicle 110 to avoid maneuvers which induce higher stresses on the motor such as, for example, sharp turns or sudden stops.

In response to thermal stress of a battery of the self-driving vehicle 110, the self-driving vehicle 110 (or the vehicle processor 212 of the self-driving vehicle 110) can reduce power draw from the battery by capping acceleration and/or top speed of the self-driving vehicle 110. Additionally, or alternatively, in response to thermal stress of a battery of the self-driving vehicle 110, the self-driving vehicle 110 (or the vehicle processor 212 of the self-driving vehicle 110) can prioritize flat and/or low-incline routes to avoid high current spikes.

In response to an imbalanced state of charge (SoC) of a battery of the self-driving vehicle 110, the self-driving vehicle (or the vehicle processor 212 of the self-driving vehicle 110) can adjust driving patterns of the self-driving vehicle 110 to allow passive rebalancing of the battery (such as by having consistent low-speed driving, for example). Additionally, or alternatively, in response to an imbalanced state of charge (SoC) of a battery of the self-driving vehicle 110, the self-driving vehicle 110 (or the vehicle processor 212 of the self-driving vehicle 110) can avoid, or reduce, rapid accelerations and/or high-speed operations of the self-driving vehicle 110 which can exacerbate the imbalance of the battery.

In response to a low state of charge (SoC) of a battery of the self-driving vehicle 110, the self-driving vehicle 110 (or the vehicle processor 212 of the self-driving vehicle 110) can limit unnecessary movement of the self-driving vehicle 110 and/or reduce a top speed of the self-driving vehicle 110 to preserve energy (or charge) of the battery. Additionally, or alternatively, in response to a low state of charge (SoC) of a battery of the self-driving vehicle 110, the self-driving vehicle 110 (or the vehicle processor 212 of the self-driving vehicle 110) can limit unnecessary sensor detection and/or software logic (or computer/processor operations).

In some embodiments, the self-driving vehicle 110 (or the vehicle processor 212 of the self-driving vehicle 110) monitors a brake system of the self-driving vehicle 110. To monitor the brake system, the self-driving vehicle 110 can, for example, monitor a stopping time of the self-driving vehicle 110 (e.g. an amount of time taken for the self-driving vehicle 110 to come to a full stop after the brake command is issued). In some embodiments, if the stopping time changes due to mechanical wear of the brake system and/or brake system delays, the self-driving vehicle 110 adjusts its braking profile to anticipate a change in stopping distances. In some embodiments, the self-driving vehicle 110 begins braking earlier when approaching obstacles, stops, etc. to compensate for an increased stopping time.

Additionally, or alternatively, the self-driving vehicle 110 (or the vehicle processor 212 of the self-driving vehicle 110) can monitor a motor system of the self-driving vehicle. To monitor the motor system, the self-driving vehicle 110 can, for example, monitor a response time of the motor system (e.g. an amount of time between a motor command being issued (or sent) and the actual motor response occurring). In some embodiments, if the motor system response time increases (such as due to one or more degraded controllers or processors, for example), the self-driving vehicle 110 adjusts its driving model to factor in one or more delays due to the increased response time. In some embodiments, the self-driving vehicle 110 (or the vehicle processor 212 of the self-driving vehicle 110) smooths out acceleration and/or deceleration curves to maintain (or increase) stability while compensating for slower motor system responses.

Additionally, or alternatively, the self-driving vehicle 110 (or the vehicle processor 212 of the self-driving vehicle 110) can monitor one or more wheel-based encoder sensors of the self-driving vehicle 110. To monitor a wheel-based encoder sensor, the self-driving vehicle 110 can, for example, monitor data fluctuation of the wheel-based encoder sensor. For example, minor fluctuation in data collected by the wheel-based encoder sensor can happen due to the encoder being dirty and/or due to a condition of the wheel. In some embodiments, the self-driving vehicle 110 (or the vehicle processor 212 of the self-driving vehicle 110) applies one or more software-based filters to smooth out data collected by a wheel-based encoder sensor (such as average speed data). The data may be smoothed out to ensure (or increase the likelihood) of consistent navigation. In some embodiments, one or more redundant sensors and/or one or more predictive algorithms compensate for minor fluctuations in data collected by one or more other sensors.

Additionally, or alternatively, the self-driving vehicle 110 (or the vehicle processor 212 of the self-driving vehicle 110) can monitor one or more power delivery systems of the self-driving vehicle 110. For example, the self-driving vehicle 110 (or the vehicle processor 212 of the self-driving vehicle 110) can monitor an electric power delivery system comprising at least one contactor and/or relay. The self-driving vehicle 110 can monitor an activation time of the power delivery system (e.g. an amount of time for one or more contactors/relays to close and activate power delivery to a drivetrain (or the drive system 230) of the self-driving vehicle 110). The activation time can, for example, degrade due to wearing of one or more components of the power delivery system and/or due to capacity charge time. In some embodiments, the self-driving vehicle 110 (or the vehicle processor 212 of the self-driving vehicle 110) limits rapid start-stop cycles to prevent (or reduce) additional damage to a power delivery system of the self-driving vehicle 110. In some embodiments, in response to an increased activation time, the self-driving vehicle 110 (or the vehicle processor 212 of the self-driving vehicle 110) increases precharge time limits without compromising safety of the power delivery system.

A condition of the components of the self-driving vehicle 110 (such as, for example, a motor, drivetrain, one or more sensors, one or more power delivery systems, one or more batteries, etc.), or of the self-driving vehicle 110 as a whole, can be classified into one of a plurality of different operational states. In one example, a condition of the components of the self-driving vehicle 110, or of the self-driving vehicle 110, can be classified into one of several operational states:
i An “optimal state”. In the optimal state, the components of the self-driving vehicle 110 have full operational capability with no restrictions. The components of the self-driving vehicle 110 can be classified as being in the optimal state if all of the components are functioning as desired. The components can be determined to be functioning as desired if the components are determined to be healthy (e.g. fully operational with no faults), the sensors of the self-driving vehicle 110 are calibrated as desired and the condition of the battery (or batteries) of the self-driving vehicle 110 is determined to be in an optimal range. In some embodiments, the self-driving vehicle can be classified as being in the optimal state if all model predictions correlate well (i.e. are within normal operating tolerances) with the collected operation data.
ii A “degraded state”. In the degraded state, the components of the self-driving vehicle 110 can be safely operated with some performance limitations and/or active hardware mitigation. The components of the self-driving vehicle 110 can be determined to be in the degraded state if the self-driving vehicle 110 detects, for example, overheating of a motor, a minor motor response delay, a minor fluctuation of a wheel-based encoder, overheating of at least one battery, imbalance of at least one battery, drift of non-safety related sensors (such as a temperature sensor, an inertial measurement unit (IMU), etc., for example), loss of deceleration, loss of acceleration, loss of maneuverability, loss of maximum linear/angular velocity, loss of non-safety sensor calibration, deviation of non-safety sensor position/orientation, minor discrepancy between odometry models, combinations of two or more thereof, etc. When the self-driving vehicle 110 is in the degraded state, maintenance of the self-driving vehicle 110 can be recommended.
iii A “restricted state”. In the restricted state, the components of the self-driving vehicle 110 are operated only to complete a current mission. Users/operators of the self-driving vehicle 110 can be warned with, for example, lights and/or sounds. Once the current mission is complete, the self-driving vehicle 110 can be parked. When the self-driving vehicle 110 is in the restricted state, maintenance of the self-driving vehicle 110 can be required. The components of the self-driving vehicle 110 can be determined to be in the restricted state if the self-driving vehicle 110 detects, for example, that a battery is at a critical charge level, repeated long delays of at least one contactor (or the power delivery system in general), a severe motor response delay, a severe fluctuation of a wheel-based encoder sensor, failure of non-safety controller communication (such as, for example, communication failure between a motor controller and a computer, loss of communication with a lighting controller (such as an LED controller, for example), loss of communication with a camera when the camera is not in use, combinations of two or more thereof, etc.). Additionally, or alternatively, the self-driving vehicle 110 can, for example, be classified as being in the restricted state if major (e.g. beyond critical functional tolerances) issues are detected such as, for example, loss of deceleration, loss of maneuverability, loss of non-safety sensor calibration, loss of safety sensor calibration, deviation of non-safety sensor position/orientation, minor deviation of safety sensor position/orientation, major discrepancy between odometry models, an odometry model indicates a non-safety sensor fault, combinations of two or more thereof, etc.
iv A “faulted state”. In the faulted state, the components of the self-driving vehicle 110 (or the self-driving vehicle 110 generally) are not operational due to one or more detected critical failures (such as safety related failures, for example) or the self-driving vehicle 110 is only capable of being operated manually by a user/operator (i.e. cannot be operated autonomously). In the faulted state, operation of the self-driving vehicle 110 can be stopped immediately. When the self-driving vehicle 110 is in the faulted state, maintenance of the self-driving vehicle 110 can be required. The self-driving vehicle 110 can determine that one or more critical failures have occurred if the self-driving vehicle 110 detects, for example, a drivetrain failure, at least one violation of a safety-critical sensor, communication loss (or failure) with a safety critical system, etc. Additionally, or alternatively, the self-driving vehicle 110 can, for example, be classified as being in the faulted state if, for example, there has been a major loss of safety sensor calibration and/or major deviation of safety sensor position/orientation.

One or more components of the self-driving vehicle 110 can be tested at various stages of operation of the self-driving vehicle 110. For example, one or more of the components of the self-driving vehicle 110 can be tested in response to (or upon) the self-driving vehicle 110 being turned ON (or in response to the self-driving vehicle 110 starting-up). Such testing can verify health (or a condition) of the one or more components at a stationary state of the self-driving vehicle 110 and/or identify any faults before operation of the self-driving vehicle 110 is initiated. Additionally, or alternatively, calibration testing of one or more of the components of the self-driving vehicle 110 may be performed to establish baseline performance metrics of the one or more components as described elsewhere herein. The calibration testing can, for example, be performed at the beginning of a movement of the self-driving vehicle 110. The baseline performance metrics may be compared against reference metrics for the one or more components. Additionally, or alternatively, the one or more components may be monitored throughout operation of the self-driving vehicle 110 and the baseline performance metrics (and/or the vehicle dynamic model of the self-driving vehicle 110) may be adapted to any hardware performance deviations during operation of the self-driving vehicle 110 as discussed elsewhere herein. In some embodiments, the one or more components of the self-driving vehicle 110 are monitored continuously throughout operation of the self-driving vehicle 110. In some embodiments, the one or more components of the self-driving vehicle 110 are monitored periodically throughout operation of the self-driving vehicle 110.

Any event that causes one or more components of the self-driving vehicle 110 to be tested can be referred to as a “trigger event” herein.

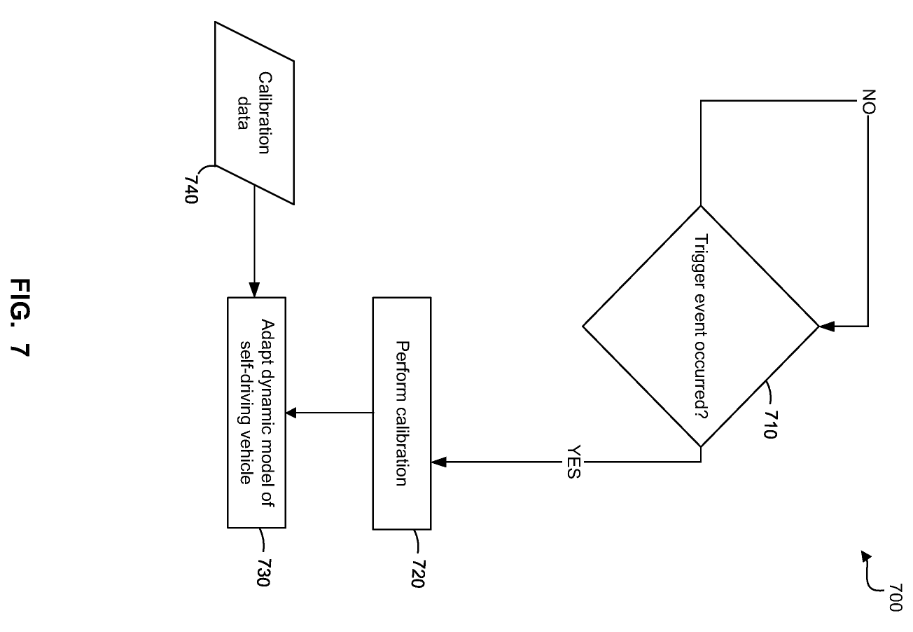

Referring to FIG. 7, there is now shown an example method 700 for updating a dynamic model of the self-driving vehicle 110.

The method 700 begins at step 710, where the vehicle processor 212 of the self-driving vehicle 110 determines whether a trigger event for testing one or more components of the self-driving vehicle 110 has occurred. If a trigger event has occurred, the method 700 may proceed to step 720. Otherwise, the method 700 may remain at step 710.

At step 720, the vehicle processor 212 of the self-driving vehicle 110 calibrates or tests the one or more components of the self-driving vehicle 110. For example, one or more calibration or testing sequences may be used to test the one or more components of the self-driving vehicle 110. Calibration data 740 may be collected during performance of the one or more calibration or testing sequences.

At step 730, the vehicle processor 212 of the self-driving vehicle 110 can adapt the dynamic model of the self-driving vehicle 110 based on the calibration data 740 or incorporate the calibration data 740 into the dynamic model of the self-driving vehicle 110.

In some embodiments, based on a defined trigger or event, a self-driving vehicle 110 can perform one or more self-diagnostic tests and re-configure its framework or re-calibrate its system(s) accordingly. For example, when a self-driving vehicle 110 is first activated, the self-driving vehicle 110 can perform a series of connectivity tests. As another example, when the self-driving vehicle 110 is powered ON, the self-driving vehicle 110 (or the vehicle processor 212 of the self-driving vehicle 110) can run one or more performance tests to ensure that components of the self-driving vehicle 110 are functioning within expected parameters. As another example, when the self-driving vehicle 110 identifies a new attachment connection (e.g. a new connection of an attachment or attachment component (e.g. an external component that gets coupled to the self-driving vehicle 110 and that is operable to perform a function that the self-driving vehicle 110 cannot otherwise perform) to the self-driving vehicle 110), the self-driving vehicle 110 can perform a series of attachment movements to ensure that the attachment is properly functioning within pre-defined parameters. As another example, when signs of degradation of the self-driving vehicle 110 are detected, the self-driving vehicle 110 (or the vehicle processor 212 of the self-driving vehicle 110) can trigger a diagnostic sequence to identify the source(s) of the degradation.

An attachment or attachment component described herein can be, or include, for example, a lift (e.g. used to raise a payload up onto and/or off of loading infrastructure), a conveyor (e.g. used to accept or deliver payloads onto and/or off of fixed conveyors), a cart attachment (used to attach (or couple) a cart to the self-driving vehicle 110 and/or decouple (or uncouple) the cart from the self-driving vehicle 110), etc.

Based on the results of the tests, the self-driving vehicle 110 can determine an appropriate course of action. As described elsewhere herein, there may be a permissible range of error within which the self-driving vehicle 110 can decide to continue to operate without intervention or to continue to operate without intervention while prompting a user/operator to intervene. Alternatively, the self-driving vehicle 110 may determine that independent intervention (by the self-driving vehicle 110 and/or by a user/operator of the self-driving vehicle 110) is required before the self-driving vehicle 110 can continue to operate.

In some embodiments, the dynamic model of the self-driving vehicle 110 further represents an expected behaviour of an attachment (or of a plurality of attachments if a plurality of attachments are connected to the self-driving vehicle 110) and the operation data collected by the self-driving vehicle 110 includes data associated with the operation of the at least one attachment. The self-driving vehicle 110 (or the vehicle processor 212 of the self-driving vehicle 110) can determine whether the operation data is indicative of an unexpected behaviour of the at least one attachment in relation to the expected behaviour of the at least one attachment as defined by the vehicle dynamic model. In some embodiments, the self-driving vehicle 110 (or the vehicle processor 212 of the self-driving vehicle 110) updates the vehicle dynamic model to represent the expected behaviour of the at least one attachment in response to the at least one attachment being connected to the self-driving vehicle 110.

In some embodiments, the type of intervention can vary depending on a set of priority levels. For instance, a drivetrain malfunction may prompt the self-driving vehicle 110 to power down to prevent further damage while a sensor malfunction may involve temporarily pausing a current task to re-calibrate the sensor (e.g. if the self-driving vehicle 110 were carrying a payload and a weight/payload sensor malfunctioned, the payload may be temporarily unloaded to re-calibrate a weight/payload sensor). In some cases, it can be determined that the malfunctioning sensor is an essential sensor and requires replacement. In some such cases the self-driving vehicle 110 may be taken out of operation until the malfunctioning sensor can be replaced. In some embodiments, the self-driving vehicle 110 (or the vehicle processor 212 of the self-driving vehicle 110) can determine that it can re-configure a component to perform the task of a malfunctioning component (such as reconfiguring a non-essential sensor that is not needed for the current task to act in place of a malfunctioning essential sensor, for example).

In some embodiments, a self-driving vehicle 110 (or the vehicle processor 212 of the self-driving vehicle 110) can self-calibrate (e.g. instead of having a user or manufacturer manually calibrate the self-driving vehicle 110). In some embodiments, a self-driving vehicle 110 regularly performs a calibration check (such as periodically, for example) to determine if its sensors are operating within a defined range (such as a defined range of a navigation specification, for example). The self-driving vehicle 110 (or the vehicle processor 212 of the self-driving vehicle 110) can, for example, be configured to recognize certain geometries. In this way, when deployed, the self-driving vehicle 110 can be able to detect whether shapes or positions of objects match its expectation and adjust or re-calibrate its sensors to correct for any differences. Such calibration checks can, for example, be performed during safety stops of the self-driving vehicle 110.

Dynamic models of the self-driving vehicles 110 that are specific/individualized to the self-driving vehicles 110 can be used for quality control of the self-driving vehicles 110. Significant discrepancy between a dynamic model specific to a self-driving vehicle 110 and the master dynamic model can indicate defects in the self-driving vehicle 110 allowing the production line to correct the defect before the self-driving vehicle 110 is sent to a customer. Lesser discrepancies can be used to tailor a self-driving vehicle’s behaviour. For example, a self-driving vehicle 110 with slightly lower acceleration capabilities can be used in a lower payload configuration where the reduced acceleration will have little impact on performance of the self-driving vehicle 110.

Additionally, or alternatively, a dynamic model of the self-driving vehicle 110 can be used to make predictions about the self-driving vehicle’s future performance during operation. By then comparing those predictions to the collected operation data (such as over a short subsequent time period following the prediction, for example), the self-driving vehicle 110 (or the vehicle processor 212 of the self-driving vehicle 110) can continuously monitor for sudden discrepancies between predicted behaviour(s) and measured behaviour(s). A sudden transition from little/few discrepancies to large/frequent discrepancies can indicate that a sudden fault of at least one component of the self-driving vehicle 110 has occurred.

Additionally, or alternatively, the adaptations/updates to a dynamic model of a self-driving vehicle 110 can represent the change of the self-driving vehicle’s behaviour over time. The self-driving vehicle 110 (or the vehicle processor 212 of the self-driving vehicle 110) can compare the adapted/updated dynamic model of the self-driving vehicle 110 to the master dynamic model to determine a degree of performance degradation of the self-driving vehicle 110 that has occurred over the course of the self-driving vehicle’s operation, and whether that degradation has passed any critical thresholds.

In some embodiments dynamic models generated for specific self-driving vehicles 110 can be used for testing and/or further development of the self-driving vehicles 110. For example, variance in the dynamic models generated for specific self-driving vehicles 110 immediately after the self-driving vehicles 110 are manufactured can indicate a range of variance that can be expected from the manufacturing process (such as a production line, for example) of the self-driving vehicles 110.

Additionally, or alternatively, one or more acceptable operation ranges (or tolerance limits) can be used for testing and/or development of the self-driving vehicles 110 since the one or more acceptable operation ranges (or tolerance limits) can represent an operational envelope for each self-driving vehicle 110.

Additionally, or alternatively, the dynamic models of the self-driving vehicles 110 can be used to analyze a rate of degradation of the self-driving vehicles 110. For example, the dynamic models of the self-driving vehicles 110 may be communicated to the fleet management system 120 and/or the data analysis system 150 (such as over the network 130). The fleet management system 120 and/or the data analysis system 150 may be caused to analyze the dynamic models of the self-driving vehicles 110 over time (such as continuously, periodically, etc., for example) to determine a rate of degradation of the self-driving vehicles 110. The rate of degradation of the self-driving vehicles 110 can be used to inform maintenance schedules, training, future design, etc. of the self-driving vehicles 110.

In some embodiments, as the number of dynamic models specific to self-driving vehicles 110 increases, the master dynamic model can be updated to better reflect the realities of self-driving vehicles 110 coming off the production line. The quality of self-driving vehicles 110 manufactured can increase over the course of production as improvements are made to the manufacturing process which can result in an increase in capabilities which may not be represented in the original master dynamic model.

In some embodiments, the self-driving vehicle 110 (or the vehicle processor 212 of the self-driving vehicle 110) transmits the operation data associated with an unexpected behaviour to a system configured to receive the operation data and to use the received operation data to predict unexpected behaviour of one or more other self-driving vehicles 110. For example, the self-driving vehicle 110 (or the vehicle processor 212 of the self-driving vehicle 110) can transmit the operation data associated with an unexpected behaviour of the self-driving vehicle 110 (such as operation data indicating motor degradation, for example) to the fleet management system 120 and/or the data analysis system 150. The fleet management system 120 and/or the data analysis system 150 can then use the received operation data to predict when such unexpected behaviour could occur in other ones of the self-driving vehicles 110 (such as when the motors of the other ones of the self-driving vehicles 110 will be similarly degraded, for example). Maintenance plans and/or schedules can then, for example, be based on such predictions.

In some embodiments, a self-driving vehicle 110 described herein includes, or is, an autonomous mobile robot (AMR).

A “wheel-based encoder” described herein can be or include, but is not limited to, an optical encoder, a magnetic encoder or a capacitive encoder. The wheel-based encoder can, for example, be positioned proximal to or on an output shaft of a motor of a self-driving vehicle 110. As another example, the wheel-based encoder can be positioned proximal to or on a drive shaft of one or more wheels of the self-driving vehicle 110.

The headings and Abstract of the Disclosure provided herein are for convenience only and do not interpret the scope or meaning of the embodiments.

Various embodiments in accordance with the teachings herein will be described below to provide examples of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal or a mechanical element depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

Various terms used throughout the present description may be read and understood as follows, unless the context indicates otherwise: singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof. As another example, the phrase “A, B, C or any operable combination thereof” or “any combination of A, B and C” is meant to cover any combination of elements A, B and C that provides utility which may, for example, include A, B, C, A and B, A and C, B and C, or A, B and C.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

A portion of the example embodiments of the systems, devices, or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and non-volatile memory). These devices may also have at least one input device (e.g., a keyboard, a mouse, a touchscreen, and the like) and at least one output device (e.g., a display screen, a printer, a wireless radio, and the like) depending on the nature of the device.

It should also be noted that there may be some elements that are used to implement at least part of the embodiments described herein that may be implemented via software that is written in a high-level procedural language such as object-oriented programming. The program code may be written in Java, C, C⁺⁺ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Accordingly, any module, unit, component, server, computer, terminal or device described herein that executes software instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail since these are known to those skilled in the art. Furthermore, it should be noted that this description is not intended to limit the scope of the embodiments described herein, but rather as describing exemplary implementations. Various modifications and variations may be made to these example embodiments without departing from the spirit and scope of the invention, which is limited only by the appended claims.

1. A method for improving operation of a self-driving vehicle based on continuous behavioural observations, the method comprising causing at least one processor of the self-driving vehicle to, while in operation:
collect, using at least one sensor coupled to the self-driving vehicle and in communication with the at least one processor, operation data associated with the operation of the self-driving vehicle;
determine whether the operation data is indicative of an unexpected behaviour in relation to an expected individual behaviour of the self-driving vehicle as defined by at least one vehicle dynamic model adapted to represent the expected individual behaviour of the self-driving vehicle, wherein the at least one vehicle dynamic model comprises a plurality of subsystem models each adapted to represent an expected individual behaviour of a corresponding subsystem of the self-driving vehicle; and
in response to determining the operation data is indicative of the unexpected behaviour, determine an operational response to adapt the unexpected behaviour for the self-driving vehicle based on the expected individual behaviour.

2. The method of claim 1, wherein causing the at least one processor of the self-driving vehicle to collect the operation data comprises causing the at least one processor of the self-driving vehicle to collect, using the at least one sensor coupled to the self-driving vehicle and in communication with the at least one processor, environment data associated with an environment through which the self-driving vehicle is operating.

3. The method of claim 2, wherein the environment data comprises surface data associated with a surface across which the self-driving vehicle is operating.

4. The method of claim 2, wherein the at least one sensor is configured to collect data representing performance of a system of the self-driving vehicle and the method further comprises causing the at least one processor to determine the environment data based at least partially on the performance of the system.

5. The method of claim 4, wherein the system comprises a drivetrain of the self-driving vehicle.

6. The method of claim 1, wherein causing the at least one processor of the self-driving vehicle to collect the operation data comprises causing the at least one processor of the self-driving vehicle to collect, using the at least one sensor coupled to the self-driving vehicle and in communication with the at least one processor, physical condition data associated with a physical condition of the self-driving vehicle.

7. The method of claim 6, wherein the physical condition data comprises drivetrain data associated with a state of a drivetrain of the self-driving vehicle.

8. The method of claim 6, wherein the physical condition data comprises battery data associated with a state of a battery of the self-driving vehicle.

9. The method of claim 6, wherein the physical condition data comprises payload data associated with a state of a payload of the self-driving vehicle.

10. The method of claim 1, wherein the plurality of subsystem models comprises a first subsystem model based on a first set of data and a second subsystem model based on a second set of data, the first set of data different from the second set of data.

11. A self-driving vehicle apparatus comprising at least one processor configured to, while in operation:
collect, using at least one sensor coupled to the self-driving vehicle and in communication with the at least one processor, operation data associated with the operation of the self-driving vehicle;
determine whether the operation data is indicative of an unexpected behaviour in relation to an expected individual behaviour of the self-driving vehicle as defined by at least one vehicle dynamic model adapted to represent the expected individual behaviour of the self-driving vehicle, wherein the at least one vehicle dynamic model comprises a plurality of subsystem models each adapted to represent an expected individual behaviour of a corresponding subsystem of the self-driving vehicle; and
in response to determining the operation data is indicative of the unexpected behaviour, determine an operational response to adapt the unexpected behaviour for the self-driving vehicle based on the expected individual behaviour.

12. The apparatus of claim 11, wherein the at least one processor configured to collect the operation data comprises the at least one processor configured to collect, using the at least one sensor coupled to the self-driving vehicle and in communication with the at least one processor, environment data associated with an environment through which the self-driving vehicle is operating.

13. The apparatus of claim 12, wherein the environment data comprises surface data associated with a surface across which the self-driving vehicle is operating.

14. The apparatus of claim 12, wherein the at least one sensor is configured to collect data representing performance of a system of the self-driving vehicle and the at least one processor is further configured to determine the environment data based at least partially on the performance of the system.

15. The apparatus of claim 14, wherein the system of the self-driving vehicle comprises a drivetrain of the self-driving vehicle.

16. The apparatus of claim 11, wherein the at least one processor configured to collect the operation data comprises the at least one processor configured to collect, using the at least one sensor coupled to the self-driving vehicle and in communication with the at least one processor, physical condition data associated with a physical condition of the self-driving vehicle.

17. The apparatus of claim 16, wherein the physical condition data comprises drivetrain data associated with a state of a drivetrain of the self-driving vehicle.

18. The apparatus of claim 16, wherein the physical condition data comprises battery data associated with a state of a battery of the self-driving vehicle.

19. The apparatus of claim 16, wherein the physical condition data comprises payload data associated with a state of a payload of the self-driving vehicle.

20. The apparatus of claim 11, wherein the plurality of subsystem models comprises a first subsystem model based on a first set of data and a second subsystem model based on a second set of data, the first set of data different from the second set of data.
